(19) United States
(12) Patent Application Publication
(10) Pub. No.: US 2015/0099568 A1
(43) Pub. Date: Apr. 9, 2015

(54) SYSTEMS AND METHODS FOR VISUALLY REPRESENTING PROBABILITY OF WINNING A PRIZE

(71) Applicant: Gamesys Ltd., London (GB)

(72) Inventors: Hans Elias, Hertfordshire (GB); Thomas David James Aicken, London (GB)

(21) Appl. No.: 14/509,977

(22) Filed: Oct. 8, 2014

Related U.S. Application Data
(60) Provisional application No. 61/888,334, filed on Oct. 8, 2013.

(51) Int. Cl. G07F 17/34; G07F 17/32

(52) U.S. Cl. CPC G07F 17/34; G07F 17/3213
USPC 463/20

(57) ABSTRACT

In at least one embodiment, systems provide for determining symbols for a wagering game (e.g., for a bonus round of the wagering game) by determining a wager amount associated with a player of a wagering game and selecting, based on the wager amount, a first plurality of symbols for use in representing a probability of obtaining a winning outcome in the game. The systems may further provide for determining a second plurality of symbols, the second plurality of symbols comprising the outcome, and placing into symbol positions of a game interface of the wagering game (i) the first plurality of symbols and (ii) the second plurality of symbols. After an animation of the symbol positions which displays the first plurality of symbols and the second plurality of symbols, the second plurality of symbols may be displayed along a payline to display the outcome.

### CLAIM OF PRIORITY

This application claims the benefit of U.S. Provisional Application No. 61/888,334 filed Oct. 8, 2013 in the name of Elias et al., titled SYSTEMS AND METHODS FOR VISUALLY REPRESENTING ODDS OF WINNING A PRIZE. The entirety of this Provisional Application is incorporated by reference herein for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This application relates to electronic games, such as online games which may comprise wagering games, and systems and methods for visually representing odds or probabilities (whether actual or perceived) of winning a prize or otherwise obtaining a positive outcome in a game.

### BRIEF DESCRIPTION OF THE DRAWINGS

While the invention(s) described herein are susceptible to various modifications and alternative forms, specific embodiments have been shown by way of example in the drawings and will be described in detail herein. It should be understood, however, that the embodiments are not intended to be limited to the particular forms disclosed. Rather, the description provided herein is to cover all modifications, equivalents, and alternatives falling within the spirit and scope of the invention(s) described.

FIG. 1 is a schematic diagram of an embodiment of a gaming system in accordance with one or more embodiments described herein.

FIG. 2 is a schematic diagram of an embodiment of a gaming platform in accordance with one or more embodiments described herein.

FIG. 3 is a block diagram of an embodiment of a computing device useful in a system according to one or more embodiments described herein.

FIGS. 4A through 4F together illustrate one example embodiment of a game interface (e.g., a screen shot of an online game) for facilitating a game, as it is modified over the course of multiple events in the game, in a manner consistent with one or more embodiments described herein.

FIG. 5 is a flowchart of an example process consistent with one or more embodiments described herein.

### DETAIL DESCRIPTION OF SOME EMBODIMENTS

Games, whether wagering or non-wagering, are a popular past-time for millions of people all over the world. Electronic games in particular are becoming more and more popular, particularly ones playable online using a computer connected to a network. For example, according to some reports more than 200 million people play social games every month and online games recently passed e-mail as the second-most popular activity online, second only behind social networking. Accordingly, there is a need to continue to create exciting electronic games which maintain players' interest and stand out from the multitude of available online or other electronic games (e.g., games embodied in software and playable on a player device).

In accordance with at least some embodiments, a system facilitates making available for play a plurality of games (e.g., a plurality of online games or other electronic games). In accordance with some embodiments, such games comprise both a primary game (also referred to as a first aspect of the game) and a bonus round (also referred to as a bonus game or secondary aspect of the game). In accordance with some embodiments, a visual representation of the game (e.g., a number or type of symbols used to populate reels in a reeled slot machine game) is selected or modified based on a wager amount utilized in the game. In accordance with some embodiments, the visual representation is modified or selected in order to depict visually the odds, probability or likelihood of winning a prize, a relatively high value prize or other positive result in the game (collectively referred to as “probability of winning” herein). Thus, for example, (i) a first visual representation which indicates a relatively high probability of winning may be selected for display if the wager based on which it is selected is a wager at least equal to X; (ii) a second visual representation which indicates a relatively medium probability of winning may be selected for display if the wager based on which it is selected is a wager at least equal to Y but less than X; and (iii) a third visual representation which indicates a relatively low probability of winning may be selected for display if the wager based on which it is selected is a wager less than Y. Of course, any number of wager ranges and corresponding visual representations may be used; three such ranges are described for illustrative purposes only. Alternatively, particular wager amounts may be used instead of ranges of wager amounts. A given “visual representation” corresponding to a particular wager or range of wagers may include a set (e.g., plurality) of game elements, symbols or graphics. A particular game element, symbol or graphic of a game may be included in more than one such visual representation.

The visual representation of the probability of winning in a given game event is distinct from a visual representation of the outcome of the game event (although a game element, symbol or graphic which is a component of the outcome may also be a component of the visual representation of the probability of winning). For example, in one embodiment a first process or subroutine provides for determining, based on a wager amount, the visual representation of the probability of winning in a current game event while a second and distinct process or subroutine provides for determining the outcome of the current game event. In accordance with some embodiments, even if a visual representation of the probability of winning indicates a relatively high probability that the player will win a prize (or a relatively high value prize), the outcome of the game may nevertheless indicate that the player does not win a prize (or wins a relatively low value prize).

In one embodiment, the visual representation being modified or selected comprises at least one symbol or set of symbols used to represent a determination of an outcome of the game but not the outcome itself. In another embodiment, the visual representation may comprise an animation or other special effect employed in the game.

For example, in an embodiment in which the visual representation comprises at least one symbol or set of symbols, more symbols associated with relatively higher valued prizes may be selected to populate the reels of a reeled slot machine game if a wager amount equal to or greater than a predetermined or threshold amount is used for the selection while fewer such symbols associated with the relatively higher valued prize(s) may be selected (or more symbols associated with relatively lower valued prize(s) may be selected) if the wager amount is less than the predetermined or threshold amount. An object of such an embodiment may be to encourage the player to place higher wagers, in order to achieve the visual representation which appears to indicate to the player that the player is more likely to win a relatively more valuable prize when more symbols associated with the more valuable prize are displayed during the game (e.g., on spinning reels of a reeled slot machine game).

In another example, a first special effect (e.g., a fireworks animation) may be displayed to the player during the game if the player is wagering a predetermined amount (e.g., the player is playing a max bet) but not be displayed to the player if the player is wagering less than the predetermined amount, with the special effect being associated with a higher probability of the player winning a more valuable prize or obtaining a positive result in the game. The intent of such a display being dependent the wager amount

In accordance with some embodiments, the wager amount used as a determining factor for selecting the type and/or number of symbols may comprise at least one of: (i) a most recent wager amount placed in the game; (ii) an average wager amount determined from wager amounts placed in a predetermined time period, a predetermined last number of game plays or in a current session; (iii) a historical wager amount associated with the player for whose play the symbols are being selected (e.g., a “typical” wager amount of the player, an average or mean of the last X number of wagers placed by the player, etc.). In some embodiments, the wager amount is a wager amount placed in a primary game while the symbols or set of symbols being determined is for a bonus round of the game.

In accordance with some embodiments, the modification or selection of the symbol set for populating the reels of a bonus spin (e.g., a spin of a bonus round) in a reeled slot machine game based on a wager amount is a first process or subroutine which is distinct from a second process or subroutine for determining an outcome for the reeled slot machine game. Thus, if a wager amount which is greater than a threshold amount causes, for a particular bonus spin and based on the first process or subroutine, a selection of a set of symbols which includes relatively more high value symbols (or otherwise visually represents a relatively high probability of winning) than a set of symbols which would have been selected had the wager amount been less than the threshold amount, an outcome for the bonus spin determined in accordance with the second process or subroutine may nevertheless be an outcome that corresponds to a relatively low valued prize (or no prize).

With respect to embodiments in which a probability of winning is visually represented via the symbols selected for placement on the game interface, the respective values (whether real or perceived by players) may be a factor in selecting which symbols should be included in a set of symbols corresponding to a particular wager, range of wagers or probability of winning. In many games individual symbols, even if they do not in themselves correspond to a payout or reward, may be associated with a value or relative value. Such values may or may not be known or discernable to a player. In some embodiments, such values may be ascribed to symbols specifically for purposes of implementing the replacement feature described herein while in other embodiments symbols may already be associated with respective values for other purposes or goals of the game.

A value of a symbol may be determined based on a variety of factors and the embodiments described herein are not dependent on any particular scheme or methodology of valuing symbols. For example, a value may be assigned or determined for a particular symbol based on how many winning outcomes the symbol is a component of and/or the relative value of a payout or other prize associated with the one or more winning outcomes the symbol is a component of. Consider the following example of a pay table for a fruit-themed slot machine:

TABLE 1
Example Payout Schedule for Fruit Themed Slot Machine Game

| Payline Outcome | Payout (in credits) |
|---|---|
| Bar-bar-bar | 100 |
| Plum-plum-plum | 50 |
| Bell-bell-bell | 20 |
| Orange-orange-orange | 15 |
| Cherry-cherry-cherry | 10 |
| Cherry-cherry-any | 5 |
| Cherry-any-any | 2 |

Assume, for purposes of the present embodiment, the possible symbols for this fruit-themed game are (i) bar, (ii) plum, (iii) bell, (iv) orange, (v) cherry, and (vi) banana. Assume further that, in the present non-limiting example, a higher value symbol is associated with a larger number representing the value while a lower value symbol is associated with a relatively smaller number representing the relatively lower value (of course any value representation scheme which represents relative differences in value may be employed and the embodiments described herein are not limited to any particular value representation scheme). As can be appreciated from the table above, the symbol “banana” is not a component of any winning outcome. Thus, in some embodiments the symbol “banana” may be associated with a relatively low value (e.g., a value of one (1)). The symbol “bar”, on the other hand, is a component of the highest paying winning outcome. Thus, the symbol “bar” may be associated with a relatively high value (e.g., a value of five (5)). The symbol “bell” is associated with the second highest paying winning outcome and may therefore, for purposes of the present non-limiting example, be associated with a value of four (4). The symbol “orange”, although associated with the third highest winning payout, may not necessarily be associated with the next lowest value of three (3). For example, in some embodiments the value of a symbol may be determined based on various factors. One of these factors may be the value of the payout or other prize associated with the winning outcome of which the symbol is a component. However, another factor may be the number of winning outcomes of which the particular symbol is a component. For example, in the payout schedule illustrated in Table 1 above, the symbol “orange” only appears in one winning outcome while the symbol “cherry” appears in three winning outcomes (albeit smaller value payouts). Thus, in some embodiments the symbol “cherry” may be assigned a value of three (3) while the symbol “orange” may be associated with a value of two (2). Of course, any scheme for associating relative values with symbols may be used.

In accordance with some embodiments, systems, methods and articles of manufacture provide for facilitating a selection of symbols for use in a wagering game (e.g., for use in a bonus round of a wagering game) by determining a wager amount associated with a player of a wagering game and selecting, based on the wager amount, a plurality of symbols for use in representing a determination of an outcome for the wagering game (a “first plurality of symbols” for purposes of the example embodiment). The first plurality of symbols may be selected, for example, by selecting one of (i) a first set of symbols if the wager amount is at least equal to a predetermined amount; and (ii) a second set of symbols if the wager amount is less than the predetermined amount (of course ranges of wager amounts rather than particular wager amounts may be used to define which set of symbols should be selected, and more than two sets of symbols may be available in some embodiments). A second plurality of symbols may also be determined (e.g., in accordance with a distinct process), the second plurality of symbols comprising the outcome. The second plurality of symbols may also, in some embodiments, be based on the wager amount. The second plurality of symbols may be determined, in some embodiments, based on a random or pseudo-random algorithm (e.g., utilizing a Random Number Generator), as described elsewhere herein. In one embodiment, determining the second plurality of symbols may comprise receiving an indication of the outcome and/or the second plurality of symbols from another device (e.g., a server device operable to determine the outcome based on an RNG or other algorithm). The symbol positions of a game interface are then populated by placing into the symbol positions of a game interface of the wagering game (i) the first plurality of symbols and (ii) the second plurality of symbols. In accordance with some embodiments, a single symbol is placed into a given symbol position. Thus, for example, if the game interface comprises a plurality of reels and each such reel has a plurality of symbol positions thereon, a single symbol may be placed into each such symbol position. In some embodiments, the placing may include placing each symbol of the second plurality of symbols such that is placed on a different reel. An animation of the symbol positions after the placing (e.g., an animation of the reels of a slot machine game after or as the symbols of the first plurality of symbols and the symbols of the second plurality of symbols are placed on the reels) is the displayed. This animation may be considered a representation of the determination of the outcome. Finally, upon a resolution of the game event (e.g., spin of a reeled slot machine game), the second plurality of symbols may be displayed along a payline of the game interface (e.g., a payline of the plurality of reels), in order to display an indication of the outcome.

In accordance with some embodiments, selecting the first plurality of symbols, determining the second plurality of symbols and/or placing the first plurality of symbols and the second plurality of symbols into symbol positions of a game interface may comprise at least one of (i) determining a symbol allocation (e.g., which symbols of the first plurality of symbols should be placed into which area of the game interface, such as onto which particular reel of a multi-reel slot machine game); and (ii) mapping of the symbols into particular symbol positions (e.g., determining which particular symbol should go into which particular available symbol position and storing, at least temporarily, this information for subsequent reference). In some embodiments, determining an allocation of symbols within the game interface may comprise determining a density of symbols (of symbols in general or, in some embodiments, of particular symbols or particular types of symbols) for a particular area of the game interface. For example, in some embodiments in which symbols are being placed on a reeled slot machine game, this may entail determining a density of symbols on one or more reels. For example, if it is desirable to determine that a relatively low probability of winning be conveyed to a player via the symbols placed on the reels (e.g., based on a relatively low wager amount), relatively fewer symbols may be placed on the reels such that the reels look sparser or less populated. If, on the other hand, it is desirable that a relatively high probability of winning be conveyed to the player (e.g., based on a relatively high wager amount), then more symbols (or more valuable symbols) may be placed on the reels such that the symbol density looks dense and more exciting.

In accordance with some embodiments, at least some of the games for which sets of symbols (or other visual representations) are selected based on a wager amount may include a primary aspect of the game and a bonus round, either or both of which may be embodied as a reeled slot machine. Various “reel-type” or reeled slot machine games are popular with many players, whether deployed on dedicated gaming devices (e.g., a traditional slot machine device in a casino, operable primarily to facilitate one or more slot machine games) or on non-dedicated computing devices (e.g., personal computers, mobile devices, laptops or table computers, which are operable to perform a variety of functions in addition to supporting reeled slot machine games). A reeled slot machine game typically includes a plurality of reels, each reel including a plurality of symbol positions for display of a reel symbol. Although various example provided herein are described with respect to a bonus round comprising a reeled slot machine game, the invention(s) described herein are not limited to being implemented in a game in which the bonus round of the game is a reeled slot machine game.

A “symbol” or “game symbol” is a visual representation of an element or indicia which may at least be used within the game to indicate an outcome or result in the game (e.g., used to indicate at least one of whether the player has qualified for an award, qualified to enter a bonus round, and qualified for an advantage in the bonus round). A reel symbol is a symbol output on a reel of a game interface. The term “symbol” as used herein may refer to a reeled symbol or a symbol of another type of game that is not a reel-type slot machine game (e.g., a game consisting of a grid, such as a bingo game, a representation of a card in a video poker game or any other type of interface that may be applied to embodiments described herein). A reel may be mechanical (e.g., in a physical dedicated gaming device on a casino floor) or virtual (e.g., a software representation of a reel on an electronic display of a dedicated or non-dedicated device, such as an online game playable on a mobile device or PC). In a reel-type slot machine game the reels spin (or representations of virtual reels are made to look as if they spin) after a player places a wager on the game, provides another qualifying input or another reel-initiation event occurs. The reels then stop to display generated combinations of symbols on the reels an outcome of the spin may comprise the symbols which are along a payline of the game.

As previously noted herein, the embodiments described herein are not limited to reel-type slot machine games. For example, the embodiments may be implemented in a card game (e.g., a multi-hand video poker game), a grid type game (e.g., a bingo or keno game) or any type of game in which it may be desirable to select a visual representation, based on a wager amount, to indicate a probability of winning. Thus, it should be noted that although the term “spin” is used to refer to a game event which results in an outcome, the term “spin” is intended to encompass any type of game event (not limited to a game event in a reel-type slot machine game) for which an outcome may be determined.

An “element” of a game, as the term is used herein, is a component, constituent or part of a game which is discernable from another component, constituent or part of the game. In some embodiments, an element of a game may be represented as a symbol or indicia of the game.

The “outcome” of a spin or other type of game event, as the term is used herein, is the set of symbols as displayed in a set of symbol positions which are evaluated to determine, or utilized to display, whether the spin results in an award or prize. In a reel-type slot machine game, an outcome of a spin may refer to the symbols displayed along symbol positions comprising one or more paylines of the game. If a generated symbol or combination of symbols is a winning symbol or combination of symbols (i.e., a symbol or combination of symbols associated with an award), the award corresponding to the winning symbol or winning symbol combination is provided or output. The symbols along a payline at the end of a spin (i.e., once the reels are stopped and the symbols in the symbol positions are positioned such that a player may determine whether he/she qualifies for an award as a result of the spin) are referred to as the “outcome of the payline” herein.

Certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof. Embodiments of the invention(s) are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the invention(s) herein described.

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. Other terms are defined throughout the present description.

A “game”, as the term is used herein unless specified otherwise, may comprise any game (e.g., wagering or non-wagering, electronically playable over a network) playable by one or more players in accordance with specified rules. A game may be playable on a personal computer online in web browsers, on a game console and/or on a mobile device such as a smart-phone or tablet computer. A game may also be playable on a dedicated gaming device (e.g., a slot machine in a brick-and-mortar casino). “Gaming” thus refers to play of a game.

A “casual game”, as the term is used herein unless specified otherwise, may comprise a game with simple rules with little or no time commitment on the time of a player to play. A casual game may feature, for example, very simple game play such as a puzzle or Scrabble™ game, may allow for short bursts of play (e.g., during work breaks), an ability to quickly reach a final stage and/or continuous play without a need to save the game.

A “social network game”, as used herein unless specified otherwise, refers to a type of online game that is played through a social network, and in some embodiments may feature multiplayer and asynchronous game play mechanics. A “social network” may refer to an online service, online community, platform, or site that focuses on facilitating the building of social networks or social relations among people. A social network service may, for example, consist of a representation of each user (often a profile), his/her social links, and a variety of additional services. A social network may be web-based and provide means for users to interact over the Internet, such as e-mail and instant messaging. A social network game may in some embodiments be implemented as a browser game, but can also be implemented on other platforms such as mobile devices.

A “wagering game”, as the term is used herein, may comprise a game on which a player can risk a wager or other consideration, such as, but not limited to: slot games, poker games, blackjack, baccarat, craps, roulette, lottery, bingo, keno, casino war, etc. A wager may comprise a monetary wager in the form of an amount of currency or any other tangible or intangible article having some value which may be risked on an outcome of a wagering game. “Gambling” or “wagering” refers to play of a wagering game.

The term “game provider”, as used herein unless specified otherwise, refers to an entity or system of components which provides, or facilitates the provision of, games for play and/or facilitates play of such game by use of a network such as the Internet or a proprietary or closed networks (e.g., an intranet or wide area network). For example, a game provider may operate a website which provides games in a digital format over the Internet. In some embodiments in which a game comprising a wagering game is provided, a game provider may operate or facilitate a gambling website over which wagers are accepted and results of wagering games are provided.

The terms “information” and “data”, as used herein unless specified otherwise, may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

The term “indication”, as used herein unless specified otherwise, may refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

The term “network component,” as used herein unless specified otherwise, may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

The term “player,” as used herein unless specified otherwise, may refer to any type, quantity, and or manner of entity associated with the play of a game. In some embodiments, a player may comprise an entity (i) conducting play of an online game, (ii) that desires to play a game (e.g., an entity registered and/or scheduled to play and/or an entity having expressed interest in the play of the game—e.g., a spectator) and/or may (iii) that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game).

Some embodiments described herein are associated with a “player device” or a “network device”. As used herein, a “player device” is a subset of a “network device”. The “network device”, for example, may generally refer to any device that can communicate via a network, while the “player device” may comprise a network device that is owned and/or operated by or otherwise associated with a player. Examples of player and/or network devices may include, but are not limited to: a Personal Computer (PC), a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components.

A “session” comprises a period of time spanning a plurality of event instances, game instances, spins or turns of a game, the session having a defined start and defined end. An “event instance”, “game instance”, “game event”, “session” or “turn” is triggered upon an initiation of, or request for, at least one result of the game by a player, such as an actuation of a “start” or “spin” mechanism, which initiation causes an outcome to be determined or generated (e.g., a random number generator is contacted or communicated with to identify, generate or determine a random number to be used to determine a result for the event instance). An “event instance”, “game instance”, “game event” and “turn” may be used interchangeably herein. An “event instance”, “game instance”, “game event” and “turn” may refer, or occur in, a primary game or a bonus round, mode or feature of the game and refers to an occurrence which causes a determination of a result for the game. Accordingly, a session may refer to a session of a primary game or a session of a bonus round, mode or feature of the game, depending on the context.

An “outcome” should be differentiated from a “result” in the present description in that an “outcome” is a representation of a “result”, typically comprising one or more game elements or game symbols. For example, in a “fruit themed” game, a winning outcome (i.e., an outcome corresponding to some kind of award, prize or payout) may comprise a combination of three “cherry” symbols. The “result” of this outcome may be a payout of X credits awarded to the player associated with the game. In another example, in a game in which a character moves along a game interface from a starting position to a finish position, an “outcome” of the game may comprise a symbol representing one or more movements along the interface and the “result” corresponding to this outcome may be the particular number and direction of the character's movement (e.g., three spaces backwards such that the character ends up further away from the finish line). In a session embodiment, a session result may comprise a binary result (e.g., a player or game character wins or loses the session) and/or the particular award (or magnitude of award) won or earned by the player based on the session (e.g., the number of credits awarded to the player). It should be noted that the embodiments described herein encompass prizes which may comprise awards, payouts, discounts, eligibility, advancement in a game or other benefits (whether monetary or non-monetary, tangible or intangible) to a player and that any reference to a “prize”, “award” or “payout” may refer to any or all of the foregoing, unless the context explicitly indicates otherwise.

A “bonus round”, “bonus mode” or “bonus feature” of a game, as the terms are used interchangeably herein unless indicated otherwise, may refer to a secondary phase or secondary aspect of a game, entry into which is triggered via one or more events which may occur in a base or primary phase of the game (the base or primary phase of the game is also referred to as the primary game herein). Typically, a player may be able to qualify to play a bonus round based on one or more outcomes in a primary game. A bonus round may be played in accordance with a set of rules that is different from those of a primary game, and may be accompanied by displays, colors, sounds, animated sequences, game play and/or prizes that are not part of the primary game. In one embodiment, a primary or base game application or program may include programming or instructions which will automatically begin a bonus round after the player has achieved a triggering event or qualifying condition in the primary game.

“Virtual currency” as the term is used herein unless indicated otherwise, refers to an in-game currency that may be used as part of a game or one or more games provided by a game provider as (i) currency for making wagers, and/or (ii) to purchase or access various in-game items, features, functionality or powers. References to an “award”, “prize” and/or “payout” herein are intended to encompass such in the form of virtual currency, credits, real currency or any other form of value, tangible or intangible.

A “credit balance”, as the term is used herein unless indicated otherwise, refers to (i) a balance of currency, whether virtual currency or real currency, usable for making wagers or purchases in the game (or relevant to the game), and/or (ii) another tracking mechanism for tracking a player's success or advancement in a game by deducting therefrom points or value for unsuccessful attempts at advancement and adding thereto points or value for successful attempts at advancement. A credit balance may be increased or replenished with funds external to the game. For example, a player may transfer funds to the credit balance from a financial account or a gaming establishment may add funds to the credit balance due to a promotion, award or gift to the player.

The terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable medium” and/or “tangible media” specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined above and includes many exemplary protocols that are also applicable here.

In some embodiments, one or more specialized machines such as a computerized processing device, a server, a remote terminal, and/or a customer device may implement the various practices described herein. A computer system of an gaming entity may, for example, comprise various specialized computers that interact to provide for online games as described herein.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

### DESCRIPTION OF FIGURES

### Example Systems

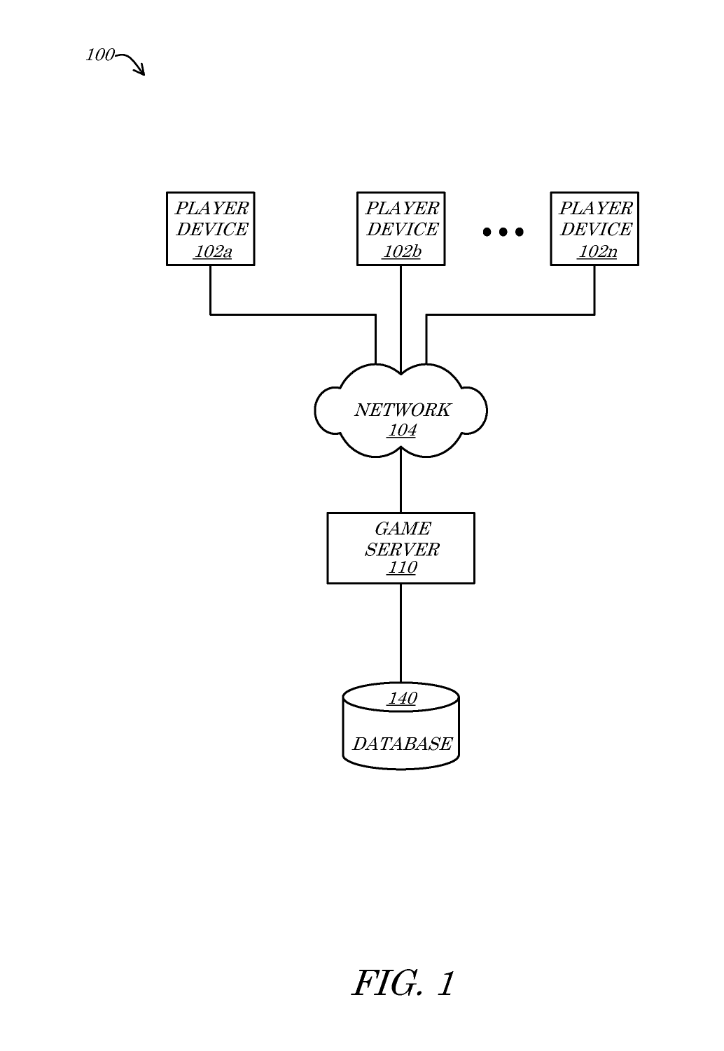

Referring now to the figures, FIG. 1 depicts a block diagram of an example system 100 according to some embodiments. The system 100 may comprise a plurality of player devices 102a-102n in communication with a game server 110 via a network 104. Game server 110 may, in some embodiments, comprise a plurality of server devices working in parallel, in series or in some other fashion which may distribute among them some of the functions described herein as being performed by game server 110. For purposes of brevity, any or all of the player devices 102a-102n will be referred to as a player device 102 herein, even though the plurality of player devices 102a-102n may include different types of player devices (as described below).

The game server 110 may also be operable to communicate with or access a database 140 (which may comprise one or more databases and/or tables (or other storage scheme for storing data) and which may comprise a storage device distinct from (or be a component of) the game server 110). It should be noted that in some embodiments database 140 may be stored on a game server 110 while in other embodiments database 140 may be stored on another computing device with which game server 110 is operable to communicate in order to at least access the data in database 140 (e.g., another server device remote from game server 140, operable to determine outcomes for an event instance of a game). In some embodiments a processor (e.g., one or more microprocessors, one or more microcontrollers, one or more digital signal processors) of a player device 102 and/or game server 110 may receive instructions (e.g., from a memory or like device), and execute those instructions, thereby performing one or more processes defined by those instructions. Instructions may be embodied in, e.g., one or more computer programs and/or one or more scripts.

In some embodiments a game server 110 and/or one or more of the player devices 102 stores and/or has access to data useful for facilitating play of a game. For example, game server 110 and/or a player device 102 may store (i) one or more probability tables or databases for determining one or more outcome(s) for an event instance, spin or turn of a game (e.g., for a bonus spin of a bonus round of the game), (ii) one or more tables or databases for selecting a set of symbols or other visual representation for use in the game, (iii) a current state or status of a game or game session (e.g., a most recent or average wager associated with a player currently playing the game), (iv) one or more user interfaces for use in a game, (v) one or more game themes for a game, (vi) one or more subroutines for facilitating the game (e.g., a subroutine for selecting symbols or other visual representation based on a wager, a subroutine or placing the selected symbols into symbol positions of the game, etc.) and/or (vii) profiles or other personal information associated with a player of a game. It should be noted that in some embodiments such data may be stored on the game server 110 and information based on such data may be output to a player device 102 during play of a game while in other embodiments a game program may be downloaded to a local memory of a player device 102 and thus such data may be stored on a player device 102 (e.g., in encrypted or other secure or tamper-resistant form).

A game server 110 may comprise a computing device for facilitating play of a game. For example, the game server may facilitate a game by (i) receiving an input from a player or player device; (ii) determining that a player has qualified for entry into a bonus round; (iii) determining a wager associated with the player (e.g., a wager the player had placed in a primary aspect of the game, prior to qualifying for the bonus round), for use in selecting symbols for the bonus round; (iv) selecting, based on the wager, a set of symbols to place into a game interface of the bonus round; (v) determining a result of the bonus round; (vi) placing symbols into the game interface of the bonus round based on the selected set of symbols and the result (which may include determining symbol allocation, density and/or mapping of the symbols onto reels); (vii) outputting an animation using the placed symbols; and (viii) display an outcome of the bonus round in order to inform the player of the result.

In one embodiment, the game server 110 may comprise a server computer operated by a game provider or another entity (e.g., a social network website not primarily directed at providing games). In some embodiments, the game server may determine an outcome for spin of a game (e.g., an outcome for a bonus spin or other event in a bonus round) by requesting and receiving such an outcome from another remote server operable to provide such outcomes. In some embodiments, the game server 110 may further be operable to facilitate a primary game program for a game (e.g., a wagering game).

In accordance with some embodiments, in addition to administering or facilitating play of a game, a game server 110 may comprise one or more computing devices responsible for handling online processes such as, but not limited to: serving a website comprising one or more games to a player device and/or processing transactions (e.g., wagers, deposits into financial accounts, managing accounts, controlling games, etc.). In some embodiments, game server 110 may comprise two or more server computers operated by the same entity (e.g., one server being primarily for storing states of games in progress and another server being primarily for storing mechanisms for determining outcomes of games, such as a random number generator).

Turning now to a description of a player device 102, in accordance with some embodiments a player device 102 may comprise a computing device that is operable to execute or facilitate the execution of a game program and used or useful by an online player for accessing an online casino or other electronic (e.g., online) game provider. For example, a player device 102 may comprise a desktop computer, computer workstation, laptop, mobile device, tablet computer, Personal Digital Assistant (PDA) devices, cellular or other wireless telephones (e.g., the Apple™ iPhone™), video game consoles (e.g., Microsoft™ Xbox 360™, Sony™ Plasystation™, and/or Nintendo™ Wii™), and/or handheld or portable video game devices (e.g., Nintendo™ Game Boy™ or Nintendo™ DS™). A player device 102 may comprise and/or interface with various components such as input and output devices (each of which is described in detail elsewhere herein) and, in some embodiments, game server 110. A player device 102 may be a dedicated gaming device (e.g., a slot machine) or a non-dedicated gaming device (e.g., an iPad™). It should be noted that a game server 110 may be in communication with a variety of different types of player devices 102.

A player device 102 may be used to play a wagering or non-wagering game (e.g., a social or casual game) over a network and output information relating to the game to players participating in the game (e.g., outcomes for an event instance of the game, qualifying for a bonus round of the game, credit balance of credits available for play of the game, a session result for a session of the game, etc.). Any and all information relevant to any of the aforementioned functions may be stored locally on one or more of the player devices 102 and/or may be accessed using one or more of the player devices 102 (in one embodiments such information being stored on, or provided via, the game server 110). In another embodiment, a player device 102 may store some or all of the program instructions for determining, for example, (i) that an event instance (e.g., a new spin or other request for a new outcome) has been triggered or initiated (and, in some embodiments, communicating such a trigger or initiation to game server 110), (ii) a first outcome for a first aspect of the game (e.g., an outcome of the primary game, which may include determining whether the outcome qualifies for initiation of a bonus round); (iii) determining a second outcome for a second aspect of the game (e.g., a plurality of symbols to represent a result for the bonus round); (iv) modifying a game interface (e.g., a game interface of a bonus round) to output symbols selected for the bonus round (e.g., including placing the symbols in the appropriate symbol positions of the game interface, and/or (iv) outputting a result of the bonus round. In some embodiments, the game server 110 may be operable to authorize the one or more player devices 102 to access such information and/or program instructions remotely via the network 104 and/or download from the game server 110 (e.g., directly or via an intermediary server such as a web server) some or all of the program code for executing one or more of the various functions described in this disclosure. In other embodiments, outcome and result determinations may be carried out by the game server 110 (or another server with which the game server 110 communicates) and the player devices 102 may be terminals for displaying to an associated player such outcomes and results and other graphics and data related to a game.

It should be noted that the one or more player devices 102 may each be located at the same location as at least one other player device 102 (e.g., such as in a casino or internet café) or remote from all other player devices 102. Similarly, any given player device may be located at the same location as the game server 110 or may be remote from the game server 110.

It should further be noted that while the game server 110 may be useful or used by any of the player devices 102 to perform certain functions described herein, the game server 110 need not control any of the player devices 102. For example, in one embodiment the game server 110 may comprise a server hosting a website of an online casino accessed by one or more of the player devices 102. In accordance with some embodiments, a player device 102 may optionally communicates with game server 110 such that each player device 102 operates as a “thin client” having relatively less functionality, a “thick client” having relatively more functionality, or with any range of functionality therebetween (e.g., an “intermediate client”).

In one embodiment, a game server 110 may not be necessary or desirable. For example, some embodiments described in this disclosure may be practiced on one or more player devices 102 without a central authority. In such an embodiment, any functions described herein as performed by a game server 110 and/or data described as stored on a game server 110 may instead be performed by or stored on one or more player devices 102. Additional ways of distributing information and program instructions among one or more player devices 102, a game server 110 and/or another server device will be readily understood by one skilled in the art upon contemplation of the present disclosure.

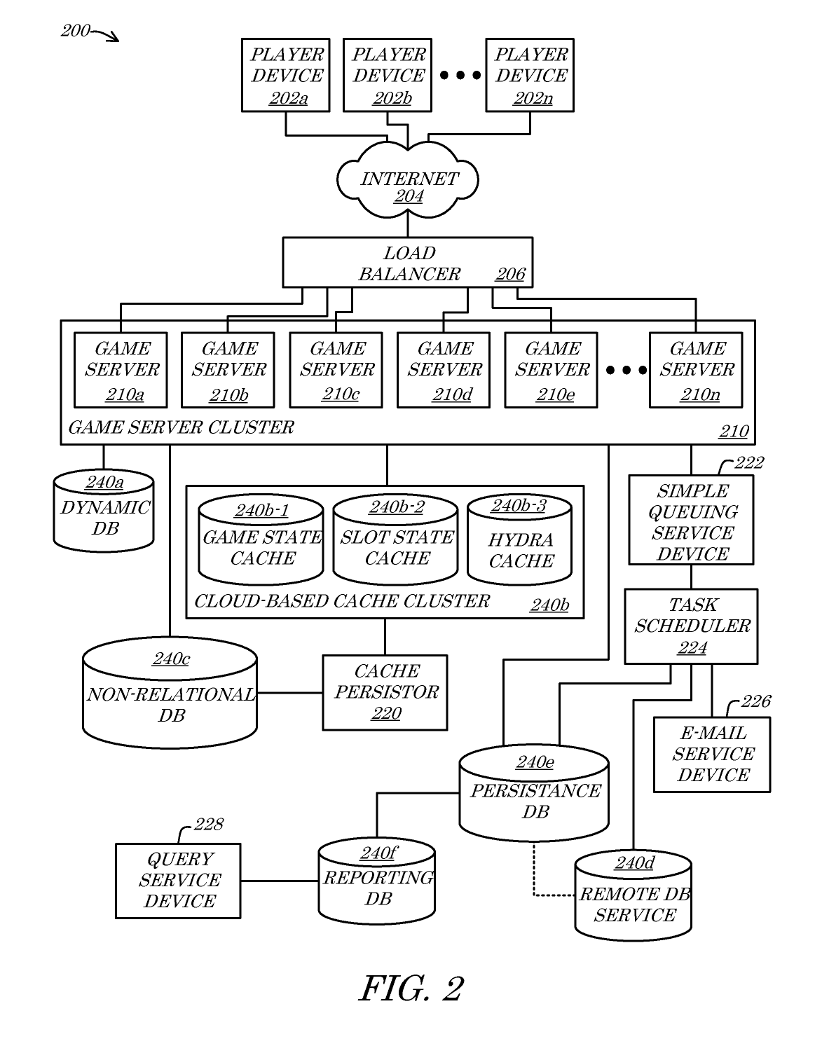

FIG. 2 a block diagram of an example system 200, which is consistent with some embodiments. In accordance with some embodiments, the system 200 may comprise a plurality of player devices 202a-n, the Internet 204, a load balancer 206, and/or a game server cluster 210. The game server cluster 210 may, in some embodiments, comprise a plurality of game servers 210a-n. In some embodiments, the system 200 may comprise a cache persistor 220, a Simple Queuing Service (SQS) device 222, a task scheduler 224, an e-mail service device 226, and/or a query service device 228. As depicted in FIG. 2, any or all of the various components 202a-n, 204, 206, 210a-n, 220, 222, 224, 226, 228 may be in communication with and/or coupled to one or more databases 240a-f. The system 200 may comprise, for example, a dynamic DataBase (DB) 240a, a cloud-based cache cluster 240b (e.g., comprising a game state cache 240b-1, a slot state cache 240b-2, and/or a “hydra” cache 240b-3), a non-relational DB 240c, a remote DB service 240d, a persistence DB 240e, and/or a reporting DB 240f.

According to some embodiments, any or all of the components 202a-n, 204, 206, 210a-n, 220, 222, 224, 226, 228, 240a-f of the system 200 may be similar in configuration and/or functionality to any similarly named and/or numbered components described herein. Fewer or more components 202a-n, 204, 206, 210a-n, 220, 222, 224, 226, 228, 240a-f (and/or portions thereof) and/or various configurations of the components 202a-n, 204, 206, 210a-n, 220, 222, 224, 226, 228, 240a-f may be included in the system 200 without deviating from the scope of embodiments described herein. While multiple instances of some components 202a-n, 210a-n, 240a-f are depicted and while single instances of other components 204, 206, 220, 222, 224, 226, 228 are depicted, for example, any component 202a-n, 204, 206, 210a-n, 220, 222, 224, 226, 228, 240a-f depicted in the system 200 may comprise a single device, a combination of devices and/or components 202a-n, 204, 206, 210a-n, 220, 222, 224, 226, 228, 240a-f, and/or a plurality of devices, as is or becomes desirable and/or practicable. Similarly, in some embodiments, one or more of the various components 202a-n, 204, 206, 210a-n, 220, 222, 224, 226, 228, 240a-f may not be needed and/or desired in the system 200.

According to some embodiments, the player device 202a-n may be utilized to access (e.g., via the Internet 204 and/or one or more other networks not explicitly shown) content provided by the game server cluster 210. The game server cluster 210 may, for example, provide, manage, host, and/or conduct various online and/or otherwise electronic games such as online bingo, slots, poker, and/or other games of chance, skill, and/or combinations thereof. In some embodiments, the various game servers 210a-n (virtual and/or physical) of the game server cluster 210 may be configured to provide, manage, host, and/or conduct individual instances of available game types. A first game server 210a, for example, may host a first particular instance of an online game consistent with embodiments described herein, a second game server 210c may host a second particular instance of an online game consistent with embodiments described herein, a third game server 210c may facilitate an online game tournament, and/or a fourth game server 210d may provide an online game in which the embodiments described herein are not utilized.

In some embodiments, the player devices 202a-n may comprise various components (hardware, firmware, and/or software; not explicitly shown) that facilitate game play and/or interaction with the game server cluster 210. The player device 202a-n may, for example, comprise a gaming client such as a software application programmed in Adobe® Flash® and/or HTML 5 that is configured to send requests to, and receive responses from, one or more of the game servers 210a-n of the game server cluster 210. In some embodiments, such an application operating on and/or via the player devices 202a-n may be configured in Model-View-Controller (MVC) architecture with a communication manager layer responsible for managing the requests to/responses from the game server cluster 210. In some embodiments, one or more of the game servers 210a-n may also or alternatively be configured in a MVC architecture with a communication manager and/or communications management layer. In some embodiments, communications between the player devices 202a-n and the game server cluster 210 may be conducted in accordance with the HyperText Transfer Protocol (HTTP) version 1.1 (HTTP/1.1) as published by the Internet Engineering Taskforce (IET) and the World Wide Web Consortium (W3C) in RFC 2616 (June 1999).

According to some embodiments, communications between the player devices 202a-n and the game server cluster 210 may be managed and/or facilitated by the load balancer 206. The load balancer 206 may, for example, route communications from player devices 202a-n to one or more of the specific game servers 210a-n depending upon various attributes and/or variables such as bandwidth availability (e.g., traffic management/volumetric load balancing), server load (e.g., processing load balancing), server functionality (e.g., contextual awareness/availability), and/or player-server history (e.g., session awareness/stickiness). In some embodiments, the load balancer 206 may comprise one or more devices and/or services provided by a third-party (not shown). The load balancer 206 may, for example, comprise an Elastic Load Balancer (ELB) service provided by Amazon® Web Services, LLC of Seattle, Wash. According to some embodiments, such as in the case that the load balancer 206 comprises the ELB or a similar service, the load balancer 206 may manage, set, determine, define, and/or otherwise influence the number of game servers 210a-n within the game server cluster 210. In the case that traffic and/or requests from the player devices 202a-n only require the first and second game servers 210a-b, for example, all other game servers 210c-n may be taken off-line, may not be initiated and/or called, and/or may otherwise not be required and/or utilized in the system 200. As demand increases (and/or if performance, security, and/or other issues cause one or more of the first and second game servers 210a-b to experience detrimental issues), the load balancer 206 may call and/or bring online one or more of the other game servers 210c-n depicted in FIG. 2. In the case that each game server 210a-n comprises an instance of an Amazon® Elastic Compute Cloud (EC2) service, the load balancer 206 may add or remove instances as is or becomes practicable and/or desirable.

In some embodiments, the load balancer 206 and/or the Internet 204 may comprise one or more proxy servers and/or devices (not shown in FIG. 2) via which communications between the player devices 202a-n and the game server cluster 210 are conducted and/or routed. Such proxy servers and/or devices may comprise one or more regional game hosting centers, for example, which may be geographically dispersed and addressable by player devices 202a-n in a given geographic proximity. In some embodiments, the proxy servers and/or devices may be located in one or more geographic areas and/or jurisdictions while the game server cluster 210 (and/or certain game servers 210a-n and/or groups of game servers 210a-n thereof) is located in a separate and/or remote geographic area and/or jurisdiction.

According to some embodiments, for some game types the game server cluster 210 may provide game outcomes to a controller device (not separately shown in FIG. 2) that times the release of game outcome information to the player devices 202a-n such as by utilizing a broadcaster device (also not separately shown in FIG. 2) that transmits the time-released game outcomes to the player devices 202a-n (e.g., in accordance with the Transmission Control Protocol (TCP) and Internet Protocol (IP) suite of communications protocols (TCP/IP), version 4, as defined by “Transmission Control Protocol” RFC 793 and/or “Internet Protocol” RFC 791, Defense Advance Research Projects Agency (DARPA), published by the Information Sciences Institute, University of Southern California, J. Postel, ed. (September 1981)).

In some embodiments, the game server cluster 210 (and/or one or more of the game servers 210a-n thereof) may be in communication with the dynamic DB 240a. According to some embodiments, the dynamic DB 240a may comprise a dynamically-scalable database service such as the DyanmoDB™ service provided by Amazon® Web Services, LLC. The dynamic DB 240a may, for example, store information specific to one or more certain game types (e.g., a reeled slots themed game) provided by the game server cluster 210 such as to allow, permit, and/or facilitate reporting and/or analysis of such information.

According to some embodiments, the game server cluster 210 (and/or one or more of the game servers 210a-n thereof) may be in communication with the cloud-based cache cluster 240b. Game state information from the game server cluster 210 may be stored in the game state cache 240b-1, for example, slot state (e.g., slot-game specific state) data may be stored in the slot state cache 240b-2, and/or other game and/or player information (e.g., progressive data, player rankings, audit data) may be stored in the hydra cache 240b-3. In some embodiments, the cache persistor 220 may move and/or copy data stored in the cloud-based cache cluster 240b to the non-relational DB 240c. The non-relational DB 240c may, for example, comprise a SimpleDB™ service provided by Amazon® Wed Services, LLC. According to some embodiments, the game server cluster 210 may generally access the cloud-based cache cluster 240b as-needed to store and/or retrieve game-related information. The data stored in the cloud-based cache cluster 240b may generally comprise a subset of the newest or freshest data, while the cache persistor 220 may archive and/or store or move such data to the non-relational DB 240c as it ages and/or becomes less relevant (e.g., once a player logs-off, once a game session and/or tournament ends). The game server cluster 210 may, in accordance with some embodiments, have access to the non-relational DB 240c as-needed and/or desired. The game servers 210a-n may, for example, be initialized with data from the non-relational DB 240c and/or may store and/or retrieve low frequency and/or low priority data via the non-relational DB 240c.

In some embodiments, the SQS device 222 may queue and/or otherwise manage requests, messages, events, and/or other tasks or calls to and/or from the server cluster 210. The SQS device 222 may, for example, prioritize and/or route requests between the game server cluster 210 and the task scheduler 224. In some embodiments, the SQS device 222 may provide mini-game and/or tournament information to the server cluster 210. According to some embodiments, the task scheduler 224 may initiate communications with the SQS device 222, the e-mail service provider 226 (e.g., providing e-mail lists), the remote DB service 240d (e.g., providing inserts and/or updates), and/or the persistence DB 240e (e.g., providing and/or updating game, player, and/or other reporting data), e.g., in accordance with one or more schedules.

According to some embodiments, the persistence DB 240e may comprise a data store of live environment game and/or player data. The game server cluster 210 and/or the task scheduler 224 or SQS device 222 may, for example, store game and/or player data to the persistence DB 240e and/or may pull and/or retrieve data from the persistence DB 240e, as-needed and/or desired. The server cluster 210 may, according to some embodiments, provide and/or retrieve spin and/or other game event info and/or configuration information via the persistence DB 240e.

In some embodiments, the reporting DB 240f may be created and/or populated based on the persistence DB 240e. On a scheduled and/or other basis, for example, a data transformation and/or mapping program may be utilized to pull data from the live environment (e.g., the persistence DB 240e) into the reporting DB 240f. The query service 228 may then be utilized, for example, to query the reporting DB 240f, without taxing the live environment and/or production system directly accessible by the game server cluster 210.

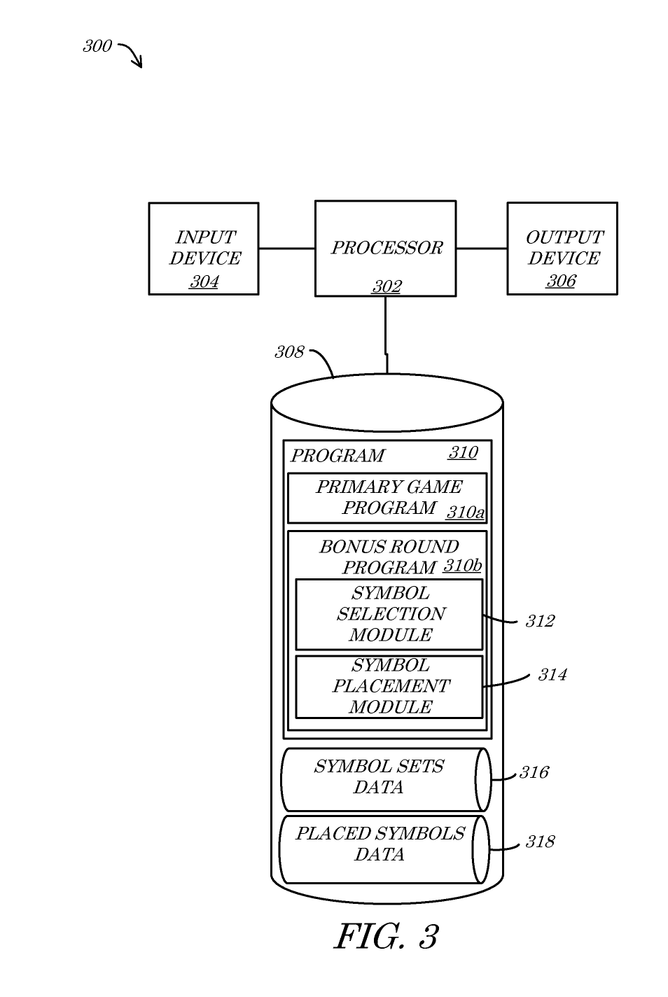

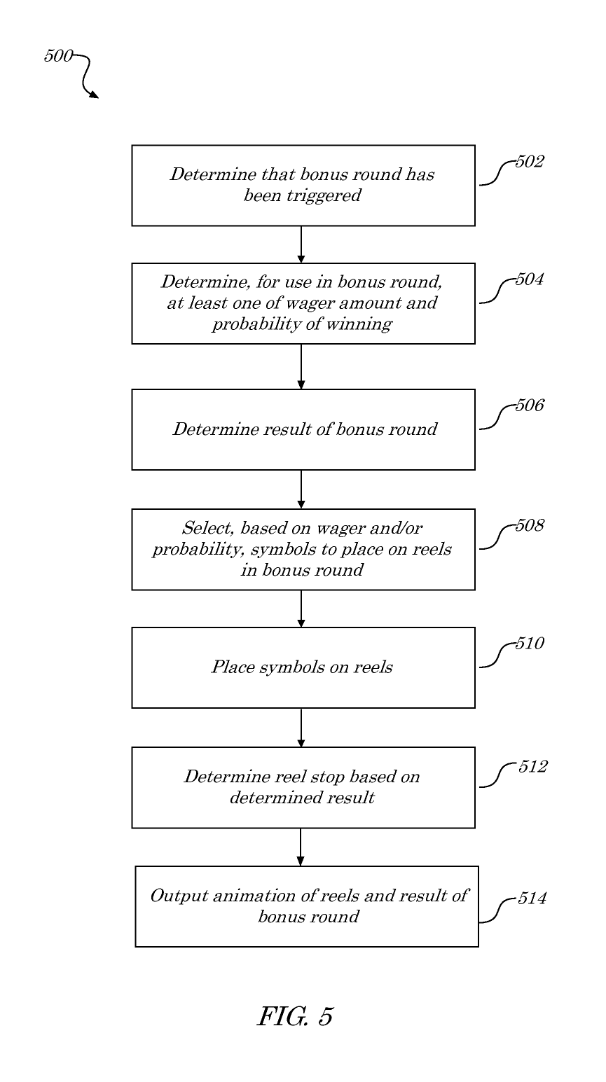

FIG. 3 is a block diagram of an apparatus 300 according to some embodiments. In some embodiments, the apparatus 300 may be similar in configuration and/or functionality to any of the player devices 102, the game server 110 and/or another server device operable to facilitate the embodiments described herein. The apparatus 300 may, for example, execute, process, facilitate, and/or otherwise be associated with any of the processes 500 and/or 600 described herein in conjunction with FIG. 5 and FIG. 6, respectively.

In some embodiments, the apparatus 300 may comprise a processor 302, an input device 304, an output device 306 and/or a memory device 308. Fewer or more components and/or various configurations of the components 302, 304, 306 and/or 308 may be included in the apparatus 300 without deviating from the scope of embodiments described herein.

According to some embodiments, the processor 302 may be or include any type, quantity, and/or configuration of processor that is or becomes known. The processor 302 may comprise, for example, an Intel® IXP 2800 network processor or an Intel® XEON™ Processor coupled with an Intel® E7501 chipset. In some embodiments, the processor 302 may comprise multiple inter-connected processors, microprocessors, and/or micro-engines. According to some embodiments, the processor 302 (and/or the apparatus 300 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 302 comprises a server such as a blade server, necessary power may be supplied via a standard AC outlet, power strip, surge protector, and/or Uninterruptible Power Supply (UPS) device.

In some embodiments, the input device 304 and/or the output device 306 are communicatively coupled to the processor 302 (e.g., via wired and/or wireless connections and/or pathways) and they may generally comprise any types or configurations of input and output components and/or devices that are or become known, respectively.

The input device 304 may comprise, for example, a keyboard that allows an operator of the apparatus 300 to interface with the apparatus 200 (e.g., by a player, an employee or other worker affiliated with either an online casino or other entity operating a system which provides games to players). In some embodiments, the input device 304 may comprise a mechanism configured to indicate to a remote server device an initiation or triggering of an event instance (e.g., that a player has actuated a “reel spin” mechanism and thus initiated a new spin of a reels-based game), such information being provided to the apparatus 300 and/or the processor 302. In such embodiments, the input device may comprise a key on a keyboard of the apparatus 300. Other examples of input devices include, but are not limited to: a game controller and/or gamepad, a bar-code scanner, a magnetic stripe reader, a pointing device (e.g., a computer mouse, touchpad, and/or trackball), a point-of-sale terminal keypad, a touch-screen, a microphone, an infrared sensor, a sonic ranger, a computer port, a video camera, a motion detector, a digital camera, a network card, a Universal Serial Bus (USB) port, a GPS receiver, a Radio Frequency Identification (RFID) receiver, a RF receiver, a thermometer, a pressure sensor, and a weight scale or mass balance.

The output device 306 may, according to some embodiments, comprise a display screen and/or other practicable output component and/or device that is operable to output information. The output device 306 may, for example, comprise a display screen via which are output outcomes, instructions, guidance, questions or information to a player of a game. For example, the output device may output a game interface for a bonus round which comprises a plurality of player selectable elements, such as the bonus round symbols populated into respective ones of a plurality of symbol positions comprising the game interface, an indication of bonus round enhancers available for use by the player during the bonus round and/or any payouts or other awards won or earned by a player as a result of an outcome of the game (primary or bonus round). Some additional examples of output devices that may be useful in some embodiments include a Cathode Ray Tube (CRT) monitor, a Liquid Crystal Display (LCD) screen, a Light Emitting Diode (LED) screen, a printer, an audio speaker, an Infra-red Radiation (IR) transmitter, an RF transmitter, and/or a data port. According to some embodiments, the input device 304 and/or the output device 306 may comprise and/or be embodied in a single device such as a touch-screen display or screen.

In some embodiments, the apparatus 300 may comprise any type or configuration of communication device (not shown) that is or becomes known or practicable. For example, the apparatus 300 may include a communication device such as a Network Interface Card (NIC), a telephonic device, a cellular network device, a router, a hub, a modem, and/or a communications port or cable. In some embodiments, the communication device may be coupled to provide data to a telecommunications device. The communication device may, for example, comprise a cellular telephone network transmission device that sends signals (e.g., an initiation of an event instance) to a server (e.g., game server 110) in communication with a plurality of player devices 102. According to some embodiments, the communication device may also or alternatively be coupled to the processor 302. In some embodiments, the communication device may comprise an IR, RF, Bluetooth™, and/or Wi-Fi® network device coupled to facilitate communications between the processor 202 and another device.

The apparatus 300 (or any system described herein, such as system 100 and/or system 200) may further comprise one or more software module(s) for directing a processor (e.g., processor 302) to perform certain functions. In accordance with some embodiments, software components, applications, routines or subroutines, or sets of instructions for causing one or more processors to perform certain functions may be referred to as “modules”. It should be noted that such modules, or any software or computer program referred to herein, may be written in any computer language and may be a portion of a monolithic code base, or may be developed in more discrete code portions, such as is typical in object-oriented computer languages. In addition, the modules, or any software or computer program referred to herein, may in some embodiments be distributed across a plurality of computer platforms, servers, terminals, and the like. For example, a given module may be implemented such that the described functions are performed by separate processors and/or computing hardware platforms.

The memory device 308 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

The memory device 308 may, according to some embodiments, store at least one program 310 for facilitating one or more of the embodiments described herein, which program may include (i) one or more primary game programs or modules 310a, each such primary game program for facilitating a respective primary aspect of a game; and (ii) one or more bonus round programs or modules 310b, each such bonus round program for facilitating a bonus round corresponding to one of the primary games available via the apparatus 300. In some embodiments, the primary game program(s) 310a and/or the bonus round program(s) 310b may be utilized by the processor 302 to provide output information via the output device 306.

The primary game program 310a may, for example, provide instructions for determining at least one of: (i) an amount of a wager being placed on an event instance of the game; (ii) an outcome for the primary game responsive to a placement of the wager or other input from a player which initiates an event instance of the game (e.g., by requesting a random number from another server or device), (iii) which symbol positions (e.g., reel positions) should be populated with which symbols based on the outcome determined for the event instance (e.g., based on a wager being placed on the event instance, in accordance with some embodiments described herein); (iv) which symbols symbol positions should be stopped along a payline, to indicate the symbols comprising the outcome determined for the event instance; (v) an amount by which the credit balance of the player should be increased based on any payouts won as a result of the outcome; and (vi) whether a bonus round has been triggered as a result of the event instance. In one embodiment, the primary game program 310a may include an RNG for generating a random number (or instructions for communicating with an RNG run on another device), game logic for determining the outcome based on the randomly generated number, and game assets (e.g., art, sound, etc.) for presenting the determined outcome to a player in an audio-visual manner. In some embodiments, the RNG, game logic, and game assets are contained within a player device (a player device comprising a “thick client” gaming terminal), within systems external to a player device (a player device comprising a “thin client” gaming terminal), or are distributed therebetween in any suitable manner (a player device comprising an “intermediate client” gaming terminal).

In accordance with some embodiments, a bonus round program 310b may function to (i) generate data for a bonus round such as by determining a wager to be used for determining a result and/or for selecting symbols or another type of visual representation for visually representing the probability of winning in the bonus round; (ii) determine a probability of winning to use for the bonus round (e.g., a probability of winning to be visually represented to the player via a selection, placement and/or density of symbols within the bonus round game interface and/or a probability of winning to be used to determine a result for the bonus round); (iii) determine a result and/or outcome for the bonus round (e.g., locally or by requesting such information from another device); (iv) select (or request, from another device a selection of, a set of symbols or other type of visual representation for visually representing a probability of winning (e.g., based on the wager and/or the probability of winning determined for the bonus round); (v) place the selected symbols within the bonus round interface (e.g., place a single symbol into a single symbol position of the game interface), which may include determining a density or other positional arrangement of the symbols (e.g., which symbols should be placed on which reels of a reeled slot machine bonus round); (vi) display an animation of the bonus round (e.g., display a visual representation of the selected symbols being placed on the reels and/or display the reels spinning, with the placed symbols thereon); and/or (vii) display the outcome of the bonus round (e.g., by displaying the symbols comprising the outcome along a payline of the reels comprising the game interface as the reels are brought to a stop).

The term “probability of winning”, as used herein, is intended to include (i) a probability of winning any prize, (ii) a probability of winning a particular prize; or (iii) a probability of winning a prize of a general magnitude or relative value (e.g., the top available prize).

In embodiments in which a probability of winning is visually represented via selection and/or placement of symbols in the bonus round interface, the selection of the symbols (or set of symbols) to be used to visually represent the probability of winning the bonus round may be implemented via a subroutine of the bonus round program, such as the Symbol Selection Module 312. Similarly, the placement of the selected symbols in the bonus round interface (e.g., determining which symbols should be placed in which symbol positions or other areas of the game interface, determining a density or other characteristic of the symbols within the game interface) may be implemented via a subroutine of the bonus round program 310b, such as Symbol Placement Module 314.

Memory 308 may, in some embodiments, store one or more databases or tables for storing data useful for implementing one or more embodiments described herein. For example, as illustrated in FIG. 3, memory 308 may store Symbol Sets Data 316 and Placed Symbols Data 318. The Symbol Sets Data 316 may comprise, for example, one or more tables or other embodiments of a plurality of available sets of symbols for use in a bonus round, each set corresponding to a respective wager, range of wagers, probability or range of probabilities. Thus, for example, if in one embodiment a wager or probability is determined for use in the bonus round in accordance with one process or subroutine, such wager or probability may be utilized to access the Symbol Sets Data 316 in order to select the set of symbols corresponding the wager or probability. The Placed Symbols Data 318 may comprise, for example, one or more tables or other embodiments of a mapping or other positioning of symbols within a bonus round interface (e.g., which symbols have been placed in which symbol positions on a set of reels comprising the bonus round interface) for use in the bonus round. For example, a subroutine of the bonus round program 310b may access the Placed Symbols Data 316 to determine which symbol positions should be stopped along a payline of the reels comprising the game interface, in order to display the desired outcome of the bonus round along the payline.

Table 2a and Table 2b below together are an example illustration of one scheme for a Symbol Sets Data 316, which stores different sets of symbols corresponding to two different wager ranges which may be determined for a bonus round. Thus, if the wager determined for use in selecting a set of symbols is within the first range, the symbol set of Table 2a is selected for use in the bonus round. If, on the other hand, the wager determined is within the second range, the symbol set of Table 2b is selected. In the example game of Table 2a and 2b, a minimum wager per game event is $0.25 and a maximum wager per game event is $2.00. Of course, any number of available sets of reels and corresponding wagers or wager ranges may be utilized and two are illustrated herein for purposes of brevity. In the embodiment illustrated in Tables 2a and 2b, the data for each set of symbols includes reel mapping data: an indication of not only which symbols are included in the set of symbols but also an indication of the particular reel and symbol position of the reel that each symbol of a set should be placed in. The example game illustrated via Tables 2a and 2b assumes there are three (3) reels identified as reel “1”, “2” and “3” and eight (8) symbol positions on each reel. Of course, any number of reels and symbol positions may be utilized. The example game illustrated via Tables 2a and 2b further assumes that the symbols available in the game are “A”, “B”, “C” and “D”, with “A” being the most valuable symbol (e.g., because it corresponds to the most valuable prize available in the bonus round), “B” being the next most valuable, “C” being the next most valuable and “D” being the least valuable.

As can be appreciated from a review of the data in Table 2a and Table 2b, a higher wager may, in accordance with some embodiments, cause a selection of a set of symbols which make it appear to the player (once the symbols are placed on the reels or other game interface of the bonus round) that the player has a relatively high probability of winning the most valuable prize. Table 2a is the set of symbols corresponding to the higher wager range and is comprises a symbol set with many more “A” symbols placed on the reels than there are the less valuable symbols. Table 2b is the set of symbols which is selected if the wager for the bonus round is within the lower wager range (between $0.25 and $1.99) and it has fewer of the most valuable symbol “A” and more of the less valuable symbols “B”, “C” and “D.”

TABLE 2a
Wager: $1.00-$2.00

| Symbol | | | |
|---|---|---|---|
| Position | Reel 1 | Reel 2 | Reel 3 |
| 1 | A | A | D |
| 2 | A | A | B |
| 3 | A | A | A |
| 4 | A | C | A |
| 5 | B | B | A |
| 6 | A | A | C |
| 7 | C | A | A |
| 8 | D | D | A |

TABLE 2b
Wager: $0.25-$1.99

| Symbol | | | |
|---|---|---|---|
| Position | Reel 1 | Reel 2 | Reel 3 |
| 1 | A | A | D |
| 2 | B | B | C |
| 3 | C | B | B |
| 4 | D | C | C |
| 5 | Empty | B | A |
| 6 | A | Empty | C |
| 7 | C | A | Empty |
| 8 | D | D | Empty |

In accordance with some embodiments, one manner of visually representing a lower probability of winning in a bonus round may be to have a lower density of symbols placed on the game interface of the bonus round. Accordingly, the example of Table 2b illustrates that some symbol positions of the reels may be left empty (indicated by the “Empty” data entry in the appropriate cell of the table), thus resulting in a less populated game interface with the intent to illustrate a relatively lower probability of winning the most valuable prize.

In accordance with some embodiments, each symbol set of the available symbol sets may include sufficient symbols placed in positions such that any possible outcome (which may be determined by a process or subroutine which is distinct from the process of selecting the set of symbols to place on the game interface) may be displayed to a player using the symbol set. For example, assuming the only possible outcomes of a bonus round employing the symbol sets of Tables 2a and 2b are: “A-A-A”, “B-B-B”, “C-C-C” and “D-D-D”, a review of the data in Tables 2a and 2b shows that any of these possible outcomes may be displayed to the player using either set of symbols by stopping the reels such that the appropriate symbol positions are stopped along a payline of the bonus round interface. For example, to display the outcome “D-D-D” using the set of symbols of Table 2a, Reel 1 would be stopped such that position 8 is displayed along the payline, Reel 2 would be stopped such that position 8 is displayed along the payline and Reel 3 would be stopped such that position 1 is displayed along the payline.

In other embodiments, not all sets of symbols may include sufficient symbols to display any possible outcome of the game. In such embodiments, other processes may be implemented to ensure that, given the outcome determined for the bonus round which will need to be displayed along a payline at the resolution of the bonus round, the appropriate symbols are available in appropriate symbol positions of the bonus round interface. Examples of such other processes are described herein with respect to FIG. 5.

The Symbol Sets Data 316 and/or the Placed Symbols Data 318 may, in some embodiments, be embodied as one or more databases or tables within one or more databases. In accordance with some embodiments, a database includes data, associated data structures, and database management software. A database may, for example, be implemented using any well-known database management systems, including Microsoft SQL, Oracle, IBM DB2, etc. While in some embodiments Symbol Sets Data 316 and/or the Placed Symbols Data 318 (or at least some of the data described as being stored therein) may be stored in memory 308 of apparatus 300, in other embodiments such data may be stored in another memory of another device (e.g., in a memory accessible to the memory 308 and/or to processor 302). For example, in one embodiment Symbol Sets Data 316 and/or the Placed Symbols Data 318 (or at least some of the data described as being stored therein) may be stored in a memory of a third party server, such as a server of a cloud-based computing service with which a game provider may contract for purposes of storing data.

Any or all of the exemplary instructions and data types described herein and other practicable types of data may be stored in any number, type, and/or configuration of memory devices that is or becomes known. The memory device 308 may, for example, comprise one or more data tables or files, databases, table spaces, registers, and/or other storage structures. In some embodiments, multiple databases and/or storage structures (and/or multiple memory devices 308) may be utilized to store information associated with the apparatus 300. According to some embodiments, the memory device 308 may be incorporated into and/or otherwise coupled to the apparatus 300 (e.g., as shown) or may simply be accessible to the apparatus 300 (e.g., externally located and/or situated).

In accordance with some embodiments, the apparatus 300 may function as a computer terminal and/or server of an online casino or other entity operating to provide online games, receive and/or manage information related to online games. In some embodiments, the apparatus 300 may comprise a web server and/or other server device operable to accept wagers and determine random numbers based upon which outcomes for wagering games are determined. In some embodiments, the apparatus 300 may comprise an apparatus that is operable to interact with a player of an online game. In some embodiments, apparatus 300 may comprise a plurality of devices working together to accomplish the functionality described herein with respect to FIG. 3.

### Example Interfaces

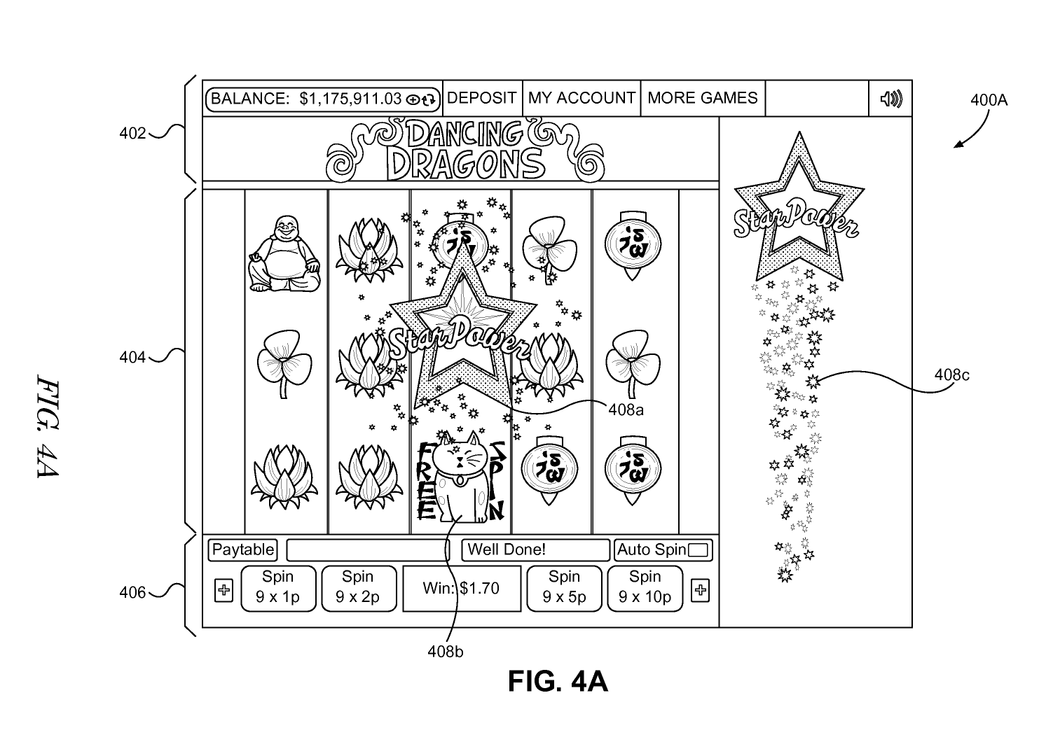

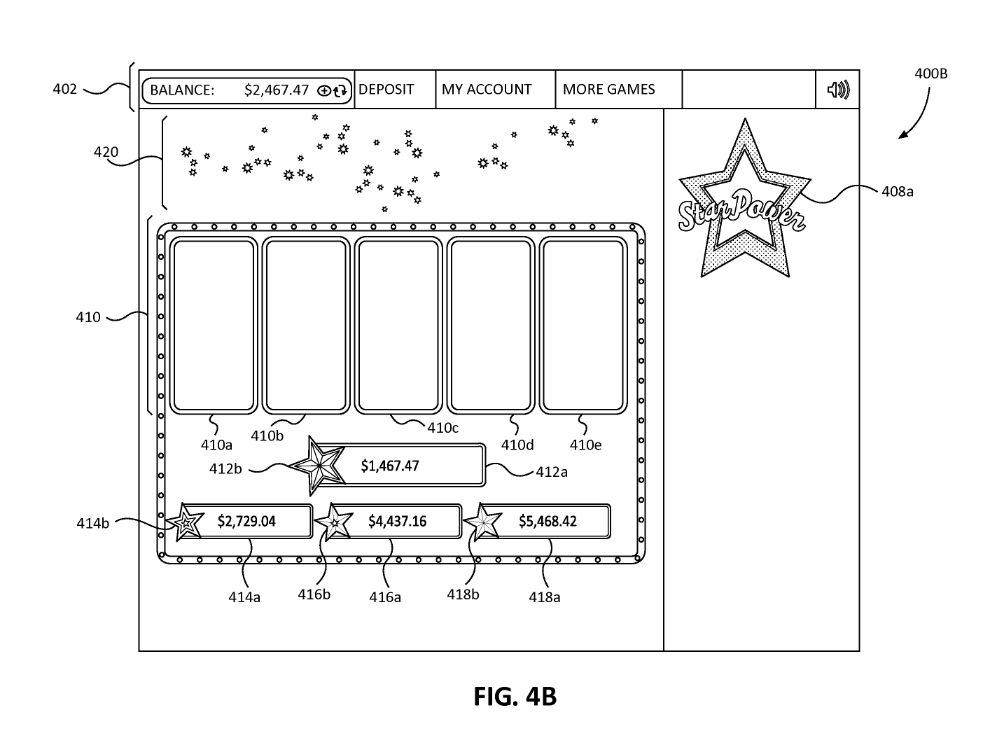

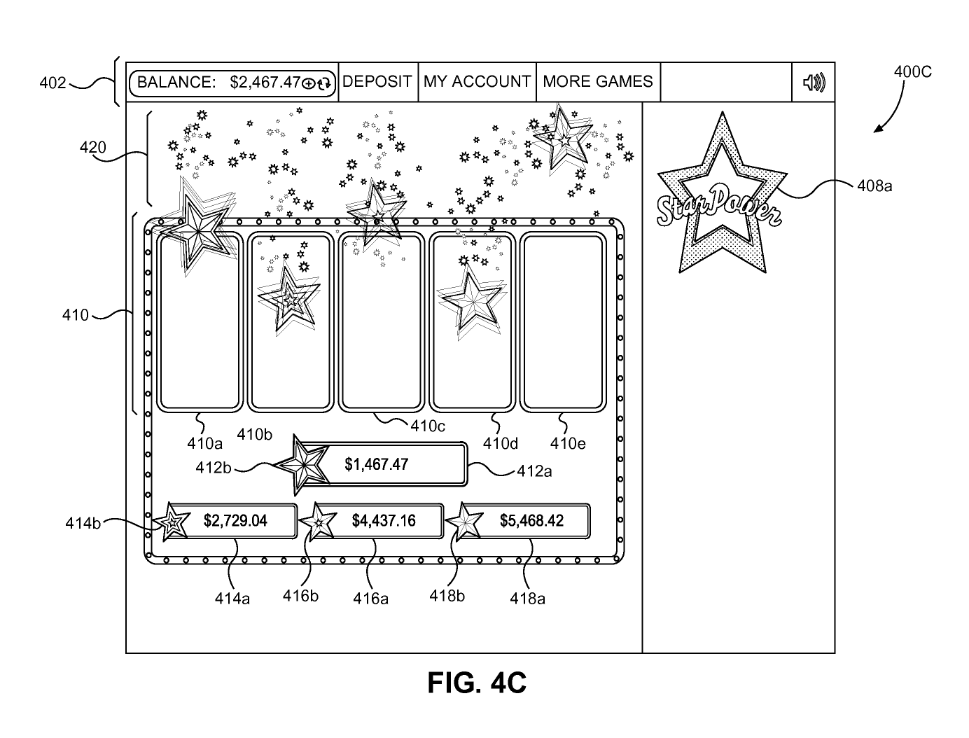

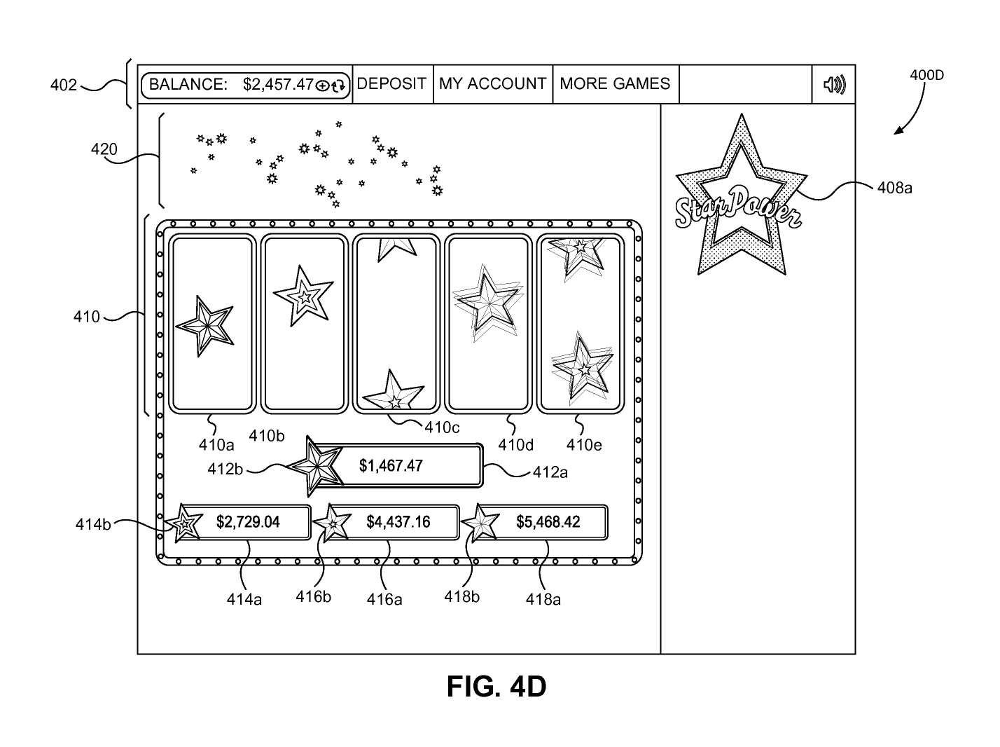

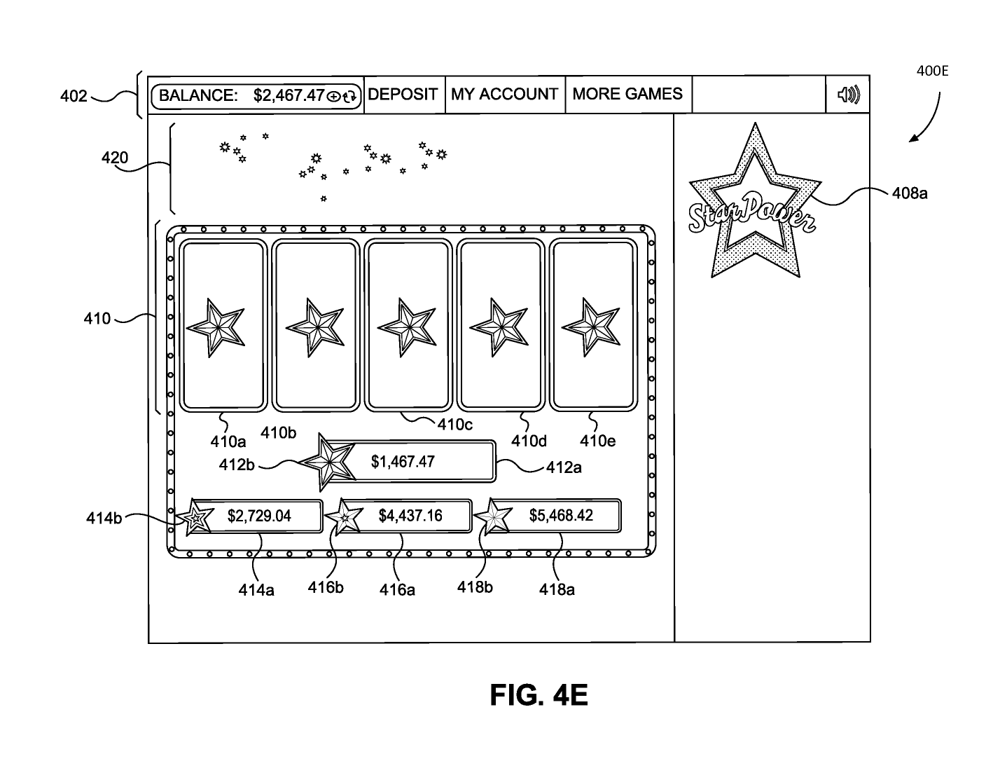

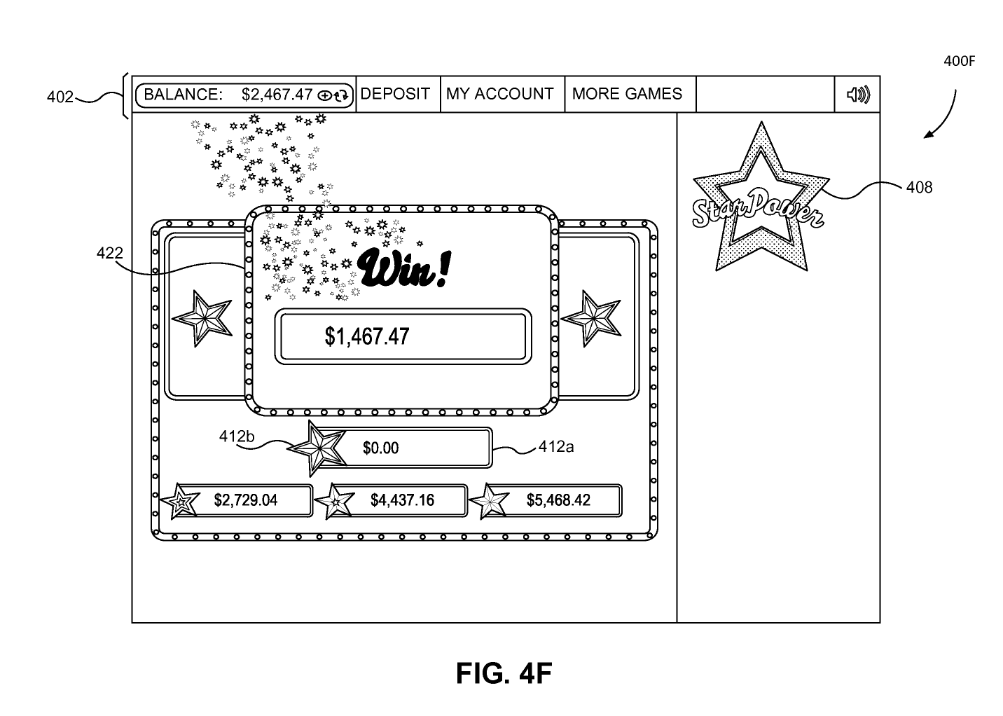

Turning now to FIGS. 4A through 4F, illustrated therein is an example of a game interface 400 as it may be modified over the course of play of a game. FIGS. 4A through 4F are one example of how some embodiments described herein may be implemented in a game comprising a primary aspect and a bonus round, and in particular how some embodiments described herein may be implemented in the bonus round, from the player's perspective. In particular, FIG. 4A illustrates a representation of an example primary game interface as it may be output to a player upon a resolution of a turn of the preprimary game, in which the player is informed that a bonus round has been triggered based on a result of the primary game while FIGS. 4B through 4F illustrate a bonus round interface of the bonus round which had been triggered, as it is modified over the course of the bonus round. FIGS. 4A through 4F each comprise a respective illustration of a screen shot which represents a “snapshot in time” of a current status of a game event, as it may be output to a player of the game.

Turning to FIG. 4A in particular, game interfaces 400A includes a plurality of areas for outputting information. It should be understood that these areas are merely one example embodiment and any other configuration or design of a primary game interface is within the scope of the invention(s) described herein.

Area 402 comprises an area for outputting the name of the game to the player (“Dancing Dragons” in the present example) as well as other general information which may be output to the player with any game the player may be playing. For example, in the example of FIG. 4A, area 402 includes an indication of a current credit balance as well as links to different pages or functionalities available from the online casino or other game provider (e.g., a link to a page which allows the player to deposit additional funds in his account, a link to a page which allows the player to view or edit his account information and a link to a page which allows the player to access additional games).

Area 404 comprises an area for outputting a representation of an outcome for the primary game, such as one or more symbols used in the primary game to indicate an outcome of the game. In accordance with some embodiments, the symbols to be output in the area 404 for a game event may be determined based on a pseudo-random process. For example, an RNG may be used to determine a random number which may then be used to determine the symbols to output in area 402. The RNG may be stored in, for example, a game server (e.g., game server 110 of FIG. 1), another server device in communication with a player device on which the game is being played or the player device itself. In some embodiments, the initiation of a game event (e.g., an initiation of a spin) or other request for an outcome of the game may cause the player device to request the outcome (or an RNG based upon which an outcome may be determined) from another device such as a game server (e.g., game server 110 of FIG. 1 or a game server 210 of FIG. 2). Thus, in some embodiments when a player places a wager and initiates a game event (e.g., by actuating or selecting the “Spin” button in area 406), this may cause at least one of a result and an outcome for the game event to be determined. For example, at least one of the following may be determined as a result of a player actuating the “Spin” command represented by the area 406: (i) the wager placed by the player on the game event (E.g., by determining which of the “Spin” button options the player has actuated in area 406); (ii) an outcome for the game event (e.g., based on the wager); (iii) whether a payout for the primary game is to be awarded to the player, based on the outcome; (iv) which symbol of a plurality of available symbols should be placed in each symbol position of the game matrix; (v) whether a bonus round has been triggered as a result of the outcome determined for the game event. Any or all of the foregoing may be determined by at least one of the player device and a remote server device, based on an RNG process or another appropriate process.

In the example of FIG. 4A, one of the symbols, symbol 408b, is a “Free Spin” symbol. In accordance with some embodiments, having at least one of these symbols appear as part of an outcome of a game event causes a bonus round to be triggered. The element 408a, imposed over the symbols of the game interface, is an element for indicating to the player that a bonus round has been triggered as a result of the game event outcome. Element 408c similarly indicates to the player that the player is about to enter the bonus round of the game. In accordance with some embodiments, a characteristic of an element for indicating that a bonus round has been triggered may be modified or selected based on a wager amount associated with the bonus round (e.g., a magnitude of the wager placed by the player on the game event which triggered the bonus round or an average wager amount placed by the player over the most recent predetermined number of game events). For example, a number or density of the small stars surrounding the large center star may be modified or selected based on the associated wager. For example, more small stars may be displayed if the wager amount is at least equal to a predetermined amount and fewer stars may be displayed if the wager amount is less than the predetermined amount. Such modification or selection of a characteristic of the element which indicates to the player that a bonus round has been triggered may be another way of visually representing to the player a probability of winning in the bonus round.

Area 406 of the screen interface outputs to the player (i) options for a plurality of wager amounts which may be placed on a game event; (ii) the total win or payout won by the player as a result of the game event; (iii) a “paytable” element or area which, if actuated or selected by the player, will cause an appropriate paytable and/or other information explaining the rules or mechanics of the game to be displayed to the player (e.g., via a new screen or pop-up window); (iv) an “Auto Spin” element or area which, if actuated or selected by the player, will cause wagers to automatically be placed for the player and successive game events to be initiated automatically for the player; and (v) one or more areas for outputting additional messages or information to the player.

Turning now to FIG. 4B, illustrated therein is an example game interface 400B, which is one embodiment of a bonus round interface which may be output to a player for a game consistent with at least some embodiments described herein. For illustrative purposes only, game interface 400B may be assumed to be the game interface of the bonus round triggered by the game event illustrated in FIG. 4A, as it may initially be displayed to the player at the beginning of a bonus round. Game interface 400B includes different areas and information for output to the player.

Game interface 400B includes an area 402 similar to the area 402 which was illustrated in game interface 400A. In the present application, like reference numerals in the figures refer to like elements. Thus, for example, in the FIGS. 4A through 4F, area 402 is repeated and the same description of area 402 with respect to one of the figures may apply to area 402 of another figures. Similarly, although the areas 410 and 420 are repeated in FIGS. 4B through 4F, the information or data illustrated in these areas may be different from figure to figure as the bonus round progresses and modifications to the game interface are illustrated via the figures as a result of the progression of the bonus round).

Area 410 of the game interface 400B an area for displaying symbols of the bonus round. In the particular embodiment being illustrated in FIGS. 4A through 4F, area 410 comprises five (5) reels 410a, 410b, 410c, 410d and 410e, each reel having a plurality of symbol positions (not shown or visible from the player's perspective, which is being illustrated). In accordance with some embodiments, area 410 is initially shown as empty at the beginning of the bonus round.

Additionally illustrated in game interface 400B is an indication of the different prizes which may be won as a result of the bonus round. In the particular example being illustrated in FIGS. 4B through 4F, there are four (4) possible prizes: (i) $1,467.47 (shown in area 412a); (ii) $2,729.04 (shown in area 414a); (iii) $4,437.16 (shown in area 416a); and (iv) $5,468.42 (shown in area 418a). In the present example, the amounts of the prizes are determined based on progressive jackpots being tracked by the game provider, such that the prize amounts may be modified as the progressive jackpot is contributed to or won. In other embodiments, the prizes of a bonus round may be static, predetermined monetary amounts or monetary amounts based on one or more different factors (e.g., data associated with the player, randomly determined amounts, etc.). Alternately, the prize(s) available in a bonus round may not be monetary in nature. For example, products or services may comprise prizes, as can benefits or advantages in a game (whether it is the game being played or a different game). The embodiments described herein are not dependent on any particular type of prize; monetary prizes are illustrated in the example of FIGS. 4B through 4F because it the relative values of such prizes are easily understood and appreciated.

Associated with each of the prize amounts indicates in areas 441a-418a are respective symbols 414b-418b. Each of the symbols 414a-418b, although being in the same shape of a star, is distinct from each of the other symbols. In the example embodiment of FIGS. 4B-4F, a player wins the prize corresponding to the symbol lines up on the reels 410a-410e at the end of the bonus round. Each bonus round ends with the same symbol appearing in the center of each reel and the player receiving the prize which corresponds to that symbol. Thus, for example, if the symbol 416b is displayed in the center of the reels at the end of the bonus round, then the player would win the corresponding prize amount of $4,437.16. As can be appreciated from a review of the symbols 412b-418b and corresponding amounts 412a-418a illustrated in FIG. 4B, the symbol 418b may be considered the most valuable symbol since it corresponds to the most valuable prize, shown in area 418a, while the symbol 412b may be considered to be the least valuable symbol since it corresponds to the least valuable prize, shown in area 412a.

Area 420 is an area for outputting one form of a visual representation to the player which may be based on the probability of winning a prize (e.g., the probability of winning the most valuable prize) in the bonus round or which may be selected or modified in order to indicate to the player the probability of winning the prize. In the example of FIGS. 4B-4D, area 420 is utilized to show small stars (representing minimized versions of the symbols of the bonus round) as they are falling onto the reels. The small stars in area 420 (or other visual representation of a probability of winning) may be output as an animation (e.g., the small stars may be shown as sprinkling or falling down towards the reels). In some embodiments, a characteristic (e.g., density or amount of the small stars in the example of FIGS. 4B through 4D) may be based on a wager amount being utilized to determine the probability of winning for the bonus round. Thus, for example, if a relatively large wager is being used to determine the probability of winning (with the probability thus being determined to be relatively high), there may be appreciably more stars shown as falling down onto the reels than if a relatively small wager is being used. Symbol 408a, on the right hand side of game interface 400B, is a symbol which indicates that the game interface is that of the bonus round.

Turning now to FIG. 4C, illustrated therein is a screen shot of the game interface 400C, which is the same game interface as that shown in FIG. 4B but at a later point in time in the bonus round (e.g., one or two seconds later), illustrating a progression of events in the bonus round. In particular, FIG. 4C illustrates more star symbols as falling through area 420 and that, as the star symbols “fall into” or appear on one of the reels 410a through 410e, they are enlarged to fit the reels. The symbols being placed on the reels through this animation are the symbols 412b-418b (the symbols comprising the outcomes which correspond to the available prizes), in accordance with some embodiments.

Turning now to FIG. 4D, illustrated therein is a screen shot of the game interface 400D, which is the same game interface as that shown in FIG. 4C but at a later point in time in the bonus round (e.g., one or two seconds later), illustrating a progression of events in the bonus round. In particular, FIG. 4D illustrates that more star symbols have been placed on the reels 410a through 410e and that the reels have now started to spin. As described herein, in some embodiments the number of symbols (e.g., in total or on a given reel) may be based on a wager amount associated with the bonus round, as may be the particular types of symbols placed on the reels. Thus, a relatively high wager amount may result in a relatively higher number of symbols, and in particular a relatively higher number of the 418b symbol, being placed on the reels. This may, in accordance with some embodiments, be done to indicate visually to the player a relatively higher probability of winning the bonus round, which has been determined based on the wager amount.

Turning now to FIG. 4E, illustrated therein is a screen shot of the game interface 400E, which is the same game interface as that shown in FIG. 4D but at a later point in time in the bonus round (e.g., one or two seconds later), illustrating a progression of events in the bonus round. In particular, FIG. 4E illustrates that five of the symbols 412b (one on each of the reels 410a through 410e) have been aligned along the reels as the reels have come to a stop. Symbol 412b corresponds to the prize of $1,467.47, indicated in area 412a.

Turning now to FIG. 4F, is a screen shot of the game interface 400F, which is the same game interface as that shown in FIG. 4E but at a later point in time in the bonus round (e.g., one or two seconds later), illustrating a progression of events in the bonus round. In particular, FIG. 4F illustrates a message output to the player, in area 422, informing the player that the prize of $1,467.47 has been won by the player. Additionally, FIG. 4F illustrates that the prize amount indicated in area 412a is now $0.00. This is because, in the example illustrated in FIGS. 4B through 4F, the prizes comprise progressive jackpots. Once a progressive jackpot is won, the amount of that jackpot is reset to zero (as would be understood by one of ordinary skill in the art of progressive jackpots). In other embodiments in which the prizes are not progressive jackpots, the prize corresponding to a particular symbol or outcome may continue to be available for a subsequent bonus round even after it has been won in a particular bonus round.

As described herein, a probability of winning as indicated via a visual representation during a bonus round (e.g., based on the number and types of symbols placed in symbol positions of a game interface comprising the bonus round) is not a guarantee or indication of what the outcome or prize will be. Thus, for example, in the embodiment of FIGS. 4A through 4F, even if the type and number of star symbols placed onto the reels 410a through 410e indicate a high probability of winning (e.g., a large number of the 418b symbols, which correspond to the most valuable possible prize) are shown as being placed onto the reels (e.g., because of a high wager amount placed by the player), the outcome of the bonus round may nevertheless be a win of a relatively low value prize (e.g., the prize indicated in area 412a). This may be because, in accordance with some embodiments, the selection and placement of symbols based on the wager amount is an indication of probability of winning a prize but not an indication of the prize which will definitely be won.

Turning now to FIG. 5, illustrated therein is a flowchart of an example process 500, which is consistent with some embodiments described herein. Process 500 comprises a process for implementing the functionality of selecting and placing symbols in a game interface of a bonus round, where the selecting and placing is based on a wager amount and is for visually representing a probability of winning the bonus round. The processes 500 may be performed, for example, by at least one of a server device operable to facilitate an electronic (e.g., online) game and/or a player device enabling a player to play the electronic (e.g., online) game. For example, the process 500 may be performed by at least one of (i) a player device 102 (FIG. 1); (ii) a game server 110 (FIG. 1); (iii) a player device 202 (FIG. 2); (iv) a game server 210 (FIG. 2); and (v) apparatus 300 (FIG. 3). Additional and/or different steps may be added to those depicted. Steps may be performed in a sequence or order different from that illustrated in FIG. 5. Not all steps depicted are necessary to any embodiment described herein. In some embodiments, significant time may pass between the execution of some steps. Process 500 may comprise a subroutine of a more general program. In one embodiment, process 500 may comprise at least a part of bonus round program 310b (FIG. 3). The process 500 is an example processes of how some embodiments described herein may be implemented, and should not be taken in a limiting fashion. A person of ordinary skill in the art, upon contemplation of the embodiments described herein, may make various modifications to process 500 without departing from the spirit and scope of the embodiments in the possession of applicants.

In step 502, it is determined that a bonus round has been triggered. For example, a triggering of a bonus round may be determined based on a result of a primary aspect of the game (e.g., based on a monitoring of the primary aspect of the game or upon receiving an indication or signal from another device of the result and/or the triggering of the bonus round). It should be noted that the embodiments described herein are not limited to use in a bonus round. For example, selecting a type, number or placement of symbols for a game interface based on a wager and/or probability of winning may be done for a primary aspect of a game or for a game which does not include both a primary aspect and a bonus round. Thus, step 502 may comprise determining that some other event has occurred which causes a selection of symbols based on a wager and/or probability of winning. The remainder of process 500 is described in the context of a bonus round for illustrative purposes only.

In step 504, at least one of a wager and a probability of winning is determined. For example, in one embodiment a wager amount (e.g., the most recent wager placed in the primary aspect of the game, such as the wager amount placed upon the game event which resulted in the bonus round being triggered) may be utilized directly for selection of symbols in the bonus round (e.g., as was illustrated and described with respect to Table 2a and 2b above). In other embodiments, a wager amount may be used indirectly in that the wager amount may be used to determine a probability of winning for the bonus round (e.g., based on a table or other scheme which correlates wagers (or wager ranges) to particular probabilities of winning), and then the determined probability of winning may be used in subsequent steps of process 500.

In step 506, a result for the bonus round is determined. The result may be determined directly or locally by the device performing process 500 or by requesting and receiving such result from another device. The result may be determined randomly and/or based on the wager amount and/or probability determined in step 504. The result may be a binary result in embodiments in which there is only one prize available in the bonus round (e.g., the result may be whether the player wins a prize or not) while in other embodiments the result may comprise a determination of which of a plurality of possible prizes the player is to win. In some embodiments, determining the result may comprise determining the corresponding outcome (i.e., which symbols represent the result).

In step 508, the symbols (and/or other visual representation(s)) for visually representing the probability of winning are selected. This selection may be performed based on the wager amount directly or indirectly (e.g., the probability of winning may be determined based on the wager amount, which probability of winning is then used to select the symbols). Selecting the symbols may comprise at least one of (i) selecting the particular symbols to be placed on the reels or other game interface; (ii) selecting a number of each particular symbol to be placed on the reels or other game interface; (iii) selecting another characteristic of the symbol(s) to be placed on the reels or other game interface (e.g., a density or positional relationship of the symbols to one another, a color or size of the symbols, whether the symbols are animate, glowing or otherwise visually enhanced, etc.).

In some embodiments, step 508 (or another step of process 500) may comprise mapping the selected symbols onto the reels or other game interface by determining which particular symbol position each selected symbol is to be placed in. For example, one or more tables such as Table 2a and Table 2b may be accessed, and the set of symbols (and corresponding symbol positions) which correspond to the wager determined in step 504 may be selected for use in the bonus round. In other embodiments, a table or other memory scheme may be accessed to determine the set of symbols for use in the bonus round but the placement or positioning of the symbols may not be predetermined; in such embodiments the placement or positioning of the symbols within the reels or other game interface may be determined anew for each bonus round (e.g., on a random basis). In some embodiments, step 508 (or another step in process 500) may comprise storing in a memory the particular symbol position each selected symbol is to be placed in, for subsequent reference (e.g., for use in determining which symbol positions should be displayed along a payline of the reels once the reels are stopped at the resolution of the bonus round).

In some embodiments, as described with respect to Table 2a and Table 2b above, each set of symbols available for selection may include a sufficient number and placement of symbols to ensure that any possible outcome may be displayed using the set of symbols. In other embodiments, however, one or more additional steps may need to be performed in order to ensure that the symbols placed on the reels include the symbols necessary to display the outcome corresponding to the result determined in step 506. For example, in one alternate embodiment the process 500 may comprise: (i) determining the at least one symbol comprising the outcome corresponding the result determined in step 504; (ii) determining the set of symbols for use in visually representing the probability of winning for the bonus round (which may comprise selecting a set of symbols from a table similar to Table 2a or Table 2b but which does not necessarily include all symbols for displaying all possible outcomes of the bonus round); (iii) placing onto the reels or other game interface the symbol(s) comprising the outcome (which, in some embodiments, may include placing the symbol(s) into the appropriate symbol positions such that the outcome may be displayed); and (iv) filling in remaining symbol positions by placing the set of symbols determined in (ii). In yet another alternate embodiment, the process 500 may comprise performing (i) and (ii) as above, then verifying whether the set of symbols determined in (ii) includes the symbols (and, in some embodiments, the symbols in the appropriate symbol positions) needed to display the outcome and, if the symbols determined in (ii) do not include the symbols needed to display the outcome, adding the necessary symbols to the set of symbols determined in (ii).

The symbols selected in step 508 are placed onto the reels or other game interface in step 510. In some embodiments, placing the symbols may comprise determining the appropriate symbol position for each symbol (e.g., based on a pre-stored symbol position, as illustrated in Table 2a and Table 2b, or based on a symbol position otherwise determined for the current bonus round). In some embodiments, step 510 may comprise outputting an animation of the symbols being placed onto the reels (e.g., as illustrated in FIGS. 4C and 4D).

In step 512, the reel stop (i.e., the symbol positions which should be stopped along a payline of the reels in order to display the outcome of the bonus round to the player) are determined. Such a determination may comprise, for example, determining the symbols comprising the outcome corresponding to the result determined in step 506, determining which symbol positions these symbols have been placed in during step 510, and selecting those symbol positions as the symbol positions which should be stopped along the payline at the resolution of the bonus round. Of course, this step 512 may occur earlier in the process 500 in some embodiments.

In step 514, an animation of the reels (e.g., showing the virtual reels as spinning, with the placed symbols thereon) is output and the reels are stopped such that the outcome corresponding to the result determined in step 506 is displayed as the outcome of the onus round.

Step 514, as any other step of process 500, may comprise causing or instructing another device or component of a device, to determine, provide, output or modify the appropriate information. Thus, for example, step 514 may comprise transmitting an instruction to a player device to display an animation of the reels, followed by a display of the outcome along a payline of the reels as the reels are brought to a stop.

The management and application of the embodiments described herein may be facilitated by a system such as system 100 (FIG. 1) or system 200 (FIG. 2), or a device included in such a system. For example, at least some processes described herein (such as the example process 500 described with respect to FIG. 5) may be performed by a device such as game server 110 (FIG. 1) or a game server 210 (FIG. 2), such as embodied as apparatus 300 of FIG. 3 in some embodiments. The system or device may be operable to perform one or more processes or subroutines to facilitate the selection of symbols for a bonus round based on a wager, to visually represent the probability of winning in the bonus round. Further, the system or device may be operable to perform at least some of the foregoing for thousands of games simultaneously. For example, the device may be operated by or on behalf of an online game provider and may be operable to facilitate play of qualifying games by thousands of online players, who may be playing a variety of different qualifying games. Thus, a system or device which implements the embodiments described herein is preferably one with sufficient processing power and memory to determine, simultaneously if necessary for all such players, the wager to be used for selecting symbols for a bonus round in order to visually represent the probability of winning in the bonus round and to select such symbols based on the wager. The system or device should further be operable to (simultaneously for thousands of players if necessary) determine a result for each bonus round and to integrate the display of the symbols representing the probability with the display of an outcome corresponding to the result.

Applicants have recognized that in the competitive business of providing entertaining games, it is challenging to provide game features which distinguish a game providers games from those of other game providers. Applicants have further recognized that today's generation of players would appreciate a visual representation of a probability of winning a bonus round, and particularly enjoy seeing a higher probability of winning in the form of more valuable symbols in the game interface if they had placed a relatively higher wager. Applicants have also further recognized that providing such an innovative visual representation of a probability of winning in the game may attract and retain players who may otherwise not have been attracted to try the game, as well as motivate players to place higher wagers.

### Rules of Interpretation

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

The Title (set forth at the beginning of the first page of this disclosure) is not to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “and/or”, when such term is used to modify a list of things or possibilities (such as an enumerated list of possibilities) means that any combination of one or more of the things or possibilities is intended, such that while in some embodiments any single one of the things or possibilities may be sufficient in other embodiments two or more (or even each of) the things or possibilities in the list may be preferred, unless expressly specified otherwise. Thus for example, a list of “a, b and/or c” means that any of the following interpretations would be appropriate: (i) each of “a”, “b” and “c”; (ii) “a” and “b”; (iii) “a” and “c”; (iv) “b” and “c”; (v) only “a”; (vi) only “b”; and (vii) only “c.”

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, component or article is described herein, more than one device, component or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component or article is described herein (whether or not they cooperate), a single device, component or article may alternatively be used in place of the more than one device, component or article that is described. For example, a plurality of computer-based devices may be substituted with a single computer-based device. Accordingly, the various functionality that is described as being possessed by more than one device, component or article may alternatively be possessed by a single device, component or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system” or program. A control system or program, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium or an article of manufacture, which may be non-transitory in nature). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory”, “article of manufacture” and/or “tangible media” specifically exclude signals, waves, and wave forms or other intangible or non-transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method of determining symbols for a wagering game, comprising:
determining, for a current game event of a wagering game, a wager amount associated with a player of the wagering game;
selecting, based on the wager amount, a plurality of symbols for use in representing a probability of obtaining a winning outcome for the current game event, thereby determining a first plurality of symbols, by selecting one of:
(i) a first set of symbols if the wager amount is at least equal to a predetermined amount; and
(ii) a second set of symbols if the wager amount is less than the predetermined amount;
determining an outcome for the current game event, the outcome comprising a second plurality of symbols;
placing into symbol positions of a game interface of the wagering game (i) the first plurality of symbols and (ii) the second plurality of symbols, wherein the game interface comprises a plurality of symbol positions and a single symbol is placed into a given symbol position, thereby determining a plurality of placed symbols;
displaying an animation of the symbol positions after the placing; and
displaying, at an end of the animation, the second plurality of symbols along a payline of the plurality of reels, thereby displaying the outcome.

2. The method of claim 1, wherein the first set of symbols includes a relatively larger number of highly valued symbols than does the second set of symbols.

3. The method of claim 2, wherein a highly valued symbol comprises a symbol which is included in an outcome corresponding to a relatively highly valued prize.

4. The method of claim 1, wherein the game interface comprises a plurality of reels, each reel of the plurality of reels comprising a plurality of symbol positions.

5. The method of claim 4, wherein placing into symbol positions of a game interface of the wagering game (i) the first plurality of symbols and (ii) the second plurality of symbols further comprises:
determining, for each symbol of the first plurality of symbols and for each symbol of the second plurality of symbols, a particular reel of the plurality of reels onto which the symbol is to be placed.

6. The method of claim 4, wherein placing into symbol positions of a game interface of the wagering game the second plurality of symbols comprises:
placing each symbol of the second plurality of symbols into a symbol position of a distinct reel, such that each symbol of the second plurality of symbols is placed onto a different reel.

7. The method of claim 1, further comprising:
displaying an animation of at least the first plurality of symbols being placed onto the game interface.

8. The method of claim 1, wherein the wager amount is at least one of: a most recent wager amount placed by the player in the wagering game, an average wager amount placed by the player and a historical wager amount placed by the player.

9. The method of claim 1, wherein the wager amount is a wager amount placed by the player in a primary aspect of the wagering game and wherein the current game event is a game event of a bonus round of the wagering game.

10. The method of claim 1, further comprising:
determining a result for the game event; and
selecting the second plurality of symbols to represent the result.

11. The method of claim 1, further comprising:
adding, prior to the displaying the second plurality of symbols comprising the outcome, the second plurality of symbols to the first plurality of symbols.

12. The method of claim 11, further comprising:
determining whether second plurality of symbols is included in the first plurality of symbols and only performing the adding step if at least one symbol of the second plurality of symbols is not included in the selected set of symbols.

13. The method of claim 1, wherein placing comprises:
first placing the second plurality of symbols into symbol positions comprising the game interface;
determining which symbols positions of the plurality of symbol positions remain unoccupied after the first placing, thereby determining unoccupied symbol positions; and
placing the second plurality of symbols into the unoccupied symbol positions.

14. The method of claim 1, wherein:
selecting the first plurality of symbols is performed in accordance with a first process; and
determining the second plurality of symbols is performed in accordance with a second process which is distinct from the first process.

15. The method of claim 1, wherein the at least one symbol comprising the second plurality of symbols is included in the first plurality of symbols

16. The method of claim 1, wherein the outcome is also determined based on the wager amount.

17. The method of claim 1, wherein determining the second plurality of symbols comprising the outcome comprises receiving an indication of the outcome from another device.

18. An apparatus, comprising:
a processor;
a memory for storing a program,
the processor being operable with the program to:
determine, for a current game event of a wagering game, a wager amount associated with a player of the wagering game;
select, based on the wager amount, a plurality of symbols for use in representing a probability of obtaining a winning outcome for the current game event, thereby determining a first plurality of symbols, by selecting one of:
(i) a first set of symbols if the wager amount is at least equal to a predetermined amount; and
(ii) a second set of symbols if the wager amount is less than the predetermined amount;
determine an outcome for the current game event, the outcome comprising a second plurality of symbols;
place into symbol positions of a game interface of the wagering game (i) the first plurality of symbols and (ii) the second plurality of symbols, wherein the game interface comprises a plurality of symbol positions and a single symbol is placed into a given symbol position, thereby determining a plurality of placed symbols;
display an animation of the symbol positions after the placing; and
display, at an end of the animation, the second plurality of symbols along a payline of the plurality of reels, thereby displaying the outcome.
